(19) United States
(12) Patent Application Publication
(10) Pub. No.: US 2026/0317463 A1
(43) Pub. Date: Oct. 15, 2026

(54) Solution Catalyst Systems and Uses Thereof

(71) Applicant: ExxonMobil Technology and Engineering Company, Spring, TX (US)

(72) Inventors: Alexander V. Zabula, Seabrook, TX (US); Torin J. Dupper, Houston, TX (US); Lubin Luo, Houston, TX (US); Jo Ann M. Canich, Houston, TX (US); Alexander Z. Voskoboynikov, Moscow (RU); Dmitry V. Uborsky, Moscow (RU); Michelle E. Titone, La Porte, TX (US); Georgy P. Goryunov, Moscow (RU)

(21) Appl. No.: 19/490,111

(22) PCT Filed: May 20, 2024
(86) PCT No.: PCT/US2024/030220

§ 371 Date: Dec. 4, 2025

Related U.S. Application Data
(60) Provisional application No. 63/506,536, filed on Jun. 6, 2023.

(51) Int. Cl. C08F 210/18

(52) U.S. Cl. CPC C08F 210/18

(57) ABSTRACT

The present disclosure relates to catalyst systems containing catalyst compounds and activators, and uses thereof. In some embodiments, a solution catalyst system includes a solution of aluminoxane comprising either anion modified alkylaluminoxane, and/or a cation modified alkylaluminoxane, the alkylaluminoxane composition having 0 wt % to about 2 wt % Al from non-coordinated trihydrocarbyl aluminum compound, based on total aluminum content of the alkylaluminoxane composition as determined by titration of the alkylaluminoxane composition with tetrahydrofuran. The catalyst system includes a compound represented by Formula (I).

### CROSS REFERENCE TO RELATED APPLICATIONS

This application claims the benefit of and priority to U.S. Provisional Application No. 63/506,536 filed Jun. 6, 2023, the disclosure of which is incorporated herein by reference.

### FIELD

The present disclosure relates to catalyst systems containing catalyst compounds and activators and uses thereof.

### BACKGROUND

Copolymers of olefins and conjugated dienes demonstrate properties that are beneficial in the tire industry—e.g., aging resistance, puncture performance, reparability, rolling resistance, and wear resistance. Copolymers formed from ethylene and butadiene monomers have been shown to improve such properties when incorporated into one or more of the components of the tires. However, the copolymerization of ethylene and butadiene can be challenging, as the difference in reaction mechanism and relative reactivity between these two monomers differ such that developing highly efficient methods of producing high molecular weight ethylene-butadiene random copolymers is difficult.

To overcome these difficulties, current efforts have focused on developing methods that implement catalyst systems that are tolerant of both monomers and capable of copolymerization of both monomers within the same process window. Example catalytic systems based on halogenated complexes of transition metals, such as titanium, have provided copolymerization of ethylene and a conjugated diene. Japanese patent specifications JP'10237131A, JP'09316118A and JP'11171930A disclose copolymers of ethylene and butadiene in which the butadiene may be inserted in the form of cyclopentyl linkages. These copolymers are obtained by a catalytic system comprising dimethylsilyl (pentamethylcyclopentadienyl)(t-butylamide)titanium dichloride and methylaluminoxane.

Active methylaluminoxane (MAO) from partially hydrolyzed trimethylaluminum (TMA) is effective in activating a type of catalyst known as metallocenes for polymerization of olefins. MAO has become the aluminum co-catalyst (also called an activator) of choice in the industry. It is available commercially in the form of 10 wt % to 30 wt % solutions in an aromatic diluent, typically toluene.

Considerable effort has been devoted to improving the effectiveness of catalyst systems for polymerization of olefins based on use of methylaluminoxanes or modified methylaluminoxanes. For example, WO 2009/029857 shows dimethylaluminum cation (AlMe₂⁺) formation from MAO upon treatment of MAO with a Lewis base, e.g., tetrahydrofuran, in a toluene solution. Lewis base stabilized dialkylaluminum cation such as AlMe₂⁺ can also be derived from non-MAO sources and used as metallocene catalyst activators; see for example Klosin et al., WO 2000/011006, and Klosin, J. et al. (2000) “Ligand Exchange and Alkyl Abstraction Involving (Perfluoroaryl)boranes and -alanes with Aluminum and Gallium Alkyls,” Organometallics, v. 19(23), pp. 4684-4686; U.S. Pat. No. 9,090,720 shows a metallocene with dimethoxy leaving groups ethylenebisindenylzirconium dimethoxide (EtInd₂Zr(OMe)₂) extracts AlMe₂⁺ from MAO to form a [EtInd₂Zr(μ-OMe)₂AlMe₂]⁺ species, which are slowly alkylated to form fully activated species [EtInd₂Zr(μ-Me)₂AlMe₂]⁺, as strong evidence of AlMe₂⁺ activation from MAO. The fully activated [EtInd₂Zr(μ-Me)₂AlMe₂]⁺ species is similar to other MAO activated metallocenes that also form the metallocene-dialkylaluminum cation species, for example, [Cp₂Zr(μ-Me)₂AlMe₂]⁺ or [Cp₂Ti(μ-Me)₂AlMe₂]⁺, such as examples in Babushkin, D. E. et al. (2002) “Activation of Dimethyl Zirconocene by Methylaluminoxane (MAO) Size Estimate for Me-MAO— Anions by Pulsed Field-Gradient NMR,” J. Am. Chem. Soc., v. 124(43), pp. 12869-12873, and Sarzotti, D. M. et al., (2007) “A kinetic study of metallocene-catalyzed ethylene polymerization using different aluminoxane cocatalysts,” J. Polymer Sci. A, v. 45(9), pp. 1677-1690, which describe the activation of a zirconocene catalyst precursor by MAO; also see Bryliakov, K. P. et al. (2004) “¹H and ¹³C NMR Spectroscopic Study of Titanium(IV) Species Formed by Activation of Cp₂TiCl₂ and [(Me₄C₅)SiMe₂N^{t}Bu]TiCl₂ with Methylaluminoxane (MAO),” Organometallics, v. 23(1), pp. 149-152, which describes activation of a titanocene catalyst precursor by MAO. Although the MAO structure is still remaining unclear, freshly made active MAO has shown evidence of coordinated TMA in MAO in agreement with the experimental formula (Al₄O₃Me₆)₄(TMA)₁₋₂ described by Sinn and Kaminsky (1999) (Sinn, et al., “Formation, Structure, and Mechanism of Oligomeric Methylaluminoxane”, in Kaminsky (ed.), Metalorg. Cat. for Synth. & Polym., Springer-Verlag, p. 105). The coordinated TMA is in equilibrium with free TMA and attempts to physically remove all free TMA result in formation of more stable inactive MAO gel. Without wishing to be bound by theory, Scheme 1 is constructed only for the purpose of helping better understanding of the gelation process by using a proposed graphic structure based on the Sinn/Kaminsky MAO formula (Al₄O₃Me₆)₄(TMA)₁₋₂. The actual MAO structure may be different.

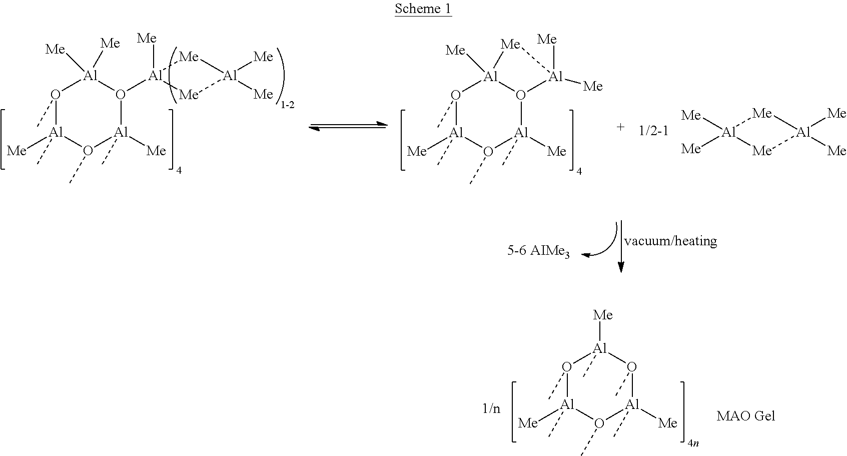

Studies have shown that the coordinated TMA in MAO actually serves as the AlMe₂⁺ source for the pre-catalyst ionization while the free TMA in MAO in equilibrium with the coordinated TMA serves as the alkylation agent as shown in Scheme 2 with the use of a circle to represent MAO main structure for clarity (Luo, Jain, and Harlan, INOR 1169, American Chemical Society Priestley Medalist Symposium in Honor of Tobin J. Marks, San Francisco, CA, Apr. 5, 2017; Luo, et al., U.S. Pat. No. 8,575,284 (2013) and 9090720 (2015)):

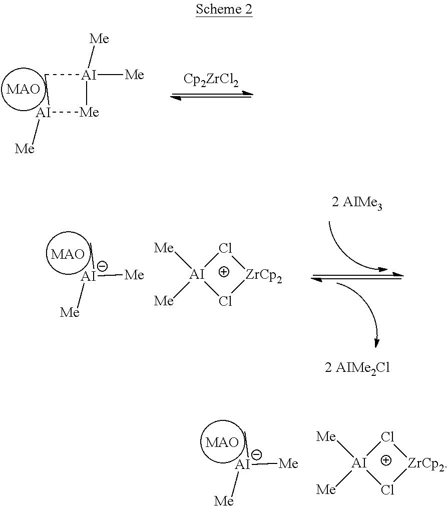

Without being bound by theory, it is believed that maintaining a significant amount of free TMA in an active MAO solution is therefore needed in order to stabilize the active MAO compositions, e.g., to stabilize the coordinated TMA capped MAO molecule structure to reduce chances of dimerization/oligomerization to eventually form the less active or inactive gel (Al:O:Me near 1:1:1) of Scheme 1. Therefore, the physical removal of free TMA not only forms less soluble MAO gel that limits the usage due to the difficulty to support or find a solvent for solution polymerization, but also causes the loss of coordinated TMA, decreasing active MAO molecule numbers, and results in a lower activation efficiency.

Nonetheless, post-metallocene catalysts and constrained-geometry-complex (CGC) catalysts containing polar ligands such as oxygen and/or nitrogen donors have displayed challenges to activate with regular MAO, showing low catalyst activity and short catalyst lifetimes. Without being bound by theory, it is believed that the poor activity and short catalyst lifetime are due to the presence of free TMA in MAO that are capable of alkylating the pre-catalyst transition metal center bonded to hetero-atoms (Scheme 3 with Zr center as example), similar to the alkylation of a metallocene with dichloride leaving groups in Scheme 2:

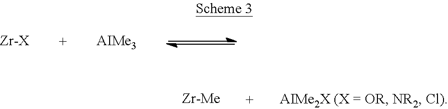

There is a need for improved catalyst systems having complimentary catalyst-activator pairs that provide polymerizing mono-olefins and conjugated dienes at high activity (e.g., within the same process window) to provide commercially scalable polymerizations (e.g., high activity under mild conditions).

References for citing in an Information Disclosure Statement (37 C.F.R. 1.97(h)) can include: U.S. Pat. Nos. 5,191,052; 8,962,744; 9,139,680; 10,030,092; 9,181,376; 9,670,302; 9,056,936; 8,969,496; 10,457,765; 10,844,149; 10,822,475; 8,039,565; 11,155,656; 11,136,422; 11,254,804; 11,286,369; 7,547,654; 10,752,712; U.S. Patent Publication Nos. 2017/0073450; 2022/0135717; PCT Publications: WO 2021/155168; WO 2021/155158; WO 2017/097831; WO 2022/112699; WO 2022/106769; WO 2021/053294; WO 2021/023924; WO 2020/128249; WO 2022/112700; WO 2022/112692; WO 2022/112690; WO 2022/112691; WO 2020/070443; Foreign Patents: CN113174401; CN113307901; EP3988583; FR3108610; JP5656686; JP5675434; JP2013155360; JP2013147567; JP5612511; JP2013159626; Journal articles: Reddy, A. et al. (2021) “Block Copolymers beneath the Surface: Measuring and Modeling Complex Morphology at the Subdomain Scale,” Macromolecules, v. 54(20), pp. 9445-9451.

### SUMMARY

The present disclosure relates to catalyst systems containing catalyst compounds and activators and uses thereof.

In some embodiments, a solution catalyst system includes:
1) an anion modified alkylaluminoxane, and/or
a cation modified alkylaluminoxane, wherein the solution catalyst system has 0 wt % to about 2 wt % Al from non-coordinated trialkylaluminum compound, based on total aluminum content of the solution catalyst system as determined by titration of the solution catalyst system with tetrahydrofuran; and
2) a compound represented by Formula (I):

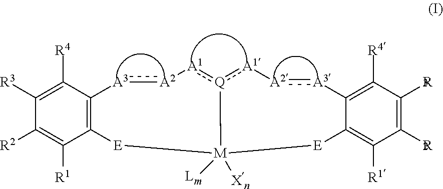

wherein:
M of is a group 3 transition metal or a lanthanide metal;
E and E′ are each independently oxygen, sulfur, or NR^{A}, wherein R^{A} is independently hydrogen, C₁-C₄₀ hydrocarbyl, substituted C₁-C₄₀ hydrocarbyl, or a heteroatom-containing group;
Q of is a group 14 atom, group 15 atom, or group 16 atom;
A¹QA^{1′} are part of a heterocyclic Lewis base containing 4 to 40 non-hydrogen atoms that links A² to A^{2′} via a 3-atom bridge with Q being central atom of the 3-atom bridge;
each of A¹ and A^{1′} is independently carbon, nitrogen, or C(R^{B}), wherein R^{B} is selected from hydrogen, C₁-C₂₀ hydrocarbyl, and substituted C₁-C₂₀ hydrocarbyl;

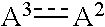

is a divalent group containing 2 to 40 non-hydrogen atoms that links A¹ to the E-bonded aryl group shown in Formula (I) via a 2-atom bridge, and A³ and A² are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings;

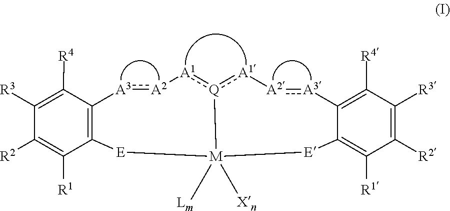

is a divalent group containing 2 to 40 non-hydrogen atoms that links A^{1′} to the E′-bonded aryl group shown in Formula (I) via a 2-atom bridge, and A^{3′} and A^{2′} are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings;
each L is independently a Lewis base;
X′ is an anionic ligand;
any two L groups may be joined together to form a bidentate Lewis base;
an X′ group may be joined to an L group to form a monoanionic bidentate group;
n is 1;
m is 0, 1, or 2;
n+m is not greater than 3; and
each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings. In some embodiments, the present disclosure provides a polymerization process including contacting one or more olefin monomers with a catalyst system including an electron withdrawing group modified alkylaluminoxane activator and a catalyst of Formula (I) of the present disclosure.

In some embodiments, the present disclosure provides a polymerization process including contacting one or more olefin monomers with a catalyst system including a siloxy donor group modified alkylaluminoxane activator and a catalyst of Formula (I) of the present disclosure.

### BRIEF DESCRIPTION OF THE DRAWINGS

FIG. 1 ¹H NMR spectrum for commercial MAO solution in THF-d8, according to some embodiments.

FIGS. 2A-B ¹H NMR spectra of a 30% commercial MAO solution after KF treatment; with FIG. 2A showing the upper solution phases after 2, 4, 7, and 10 mol % KF treatment, respectively; and with FIG. 2B showing the final K⁺(F-MAO)⁻ clathrate phase and the non-treated solution MAO for comparison.

### DETAILED DESCRIPTION

### Definitions

“Anion modified alkylaluminoxane” means an alkylaluminoxane after certain treatment by at least one new element or at least one electron-withdrawing groups. For example, a F atom or a C₆F₅ group is introduced to the alkylaluminoxane structure to give a fluorinated MAO. The reagent used to convert a regular alkylaluminoxane into an anion modified alkylaluminoxane is therefore called an anion modification agent, e.g., (NH₄)₂SiF₆ is called an anion modification agent due to its capability to convert a regular MAO into a fluorinated MAO.

The terms “anion modified alkylaluminoxane”, “anion modified aluminoxane”, “electron withdrawing group modified alkylaluminoxane”, or “electron withdrawing group modified aluminoxane” are used interchangeably.

“Cation modified alkylaluminoxane” means an alkylaluminoxane after certain treatment, wherein an ionic alkylaluminoxane forms where the cation is stabilized by at least one electron-donating group compound, e.g., a chelating agent such as octamethyltrisiloxane (OMTS). The reagent used to convert a regular alkylaluminoxane into a cation modified alkylaluminoxane is therefore called a cation modification agent, e.g., OMTS is called a cation modification agent due to its capability to convert a regular MAO into an ionic MAO. However, OMTS is a chelating agent capable of forming a very stable chelating donor stabilized dialkylaluminum cation complex [AlMe₂(OMTS)]⁺ as shown in Scheme 4 I-b, which can be heated with at least one free TMA molecule to decompose to a monodentate donor stabilized dialkylaluminum cation containing a “siloxy donor group”, e.g., Scheme 4 I-a, using the trimethylsiloxy donor group as an example, for an easier release of the AlMe₂⁺ to increase the activation efficiency. The siloxy donor group may also be introduced through other reactions, e.g., Me₃SiOH with TMA in MAO to form Me₃SiOAlMe₂ in-situ.

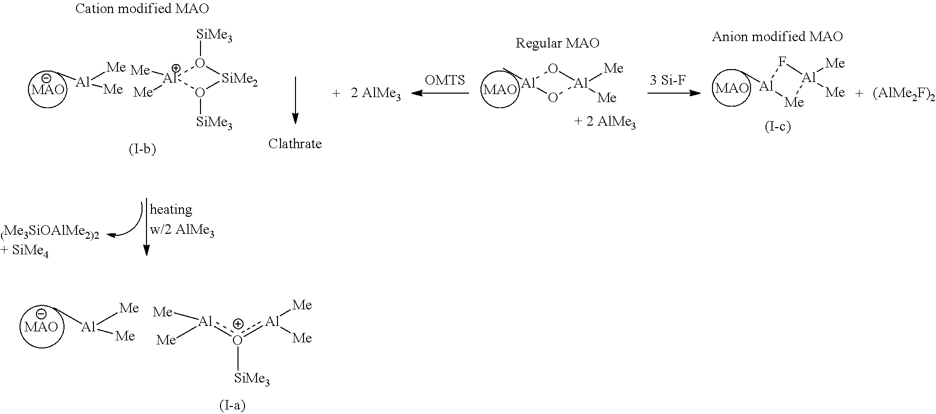

The terms “cation modified alkylaluminoxane”, “cation modified aluminoxane”, “siloxy donor group modified alkylaluminoxane”, “siloxy donor group modified aluminoxane”, “ionic alkylaluminoxane” and “ionic aluminoxane” are used interchangeably.

“Non-coordinated alkylaluminum” or “free alkylaluminum” has the same meaning to represent an aluminum compound having at least one alkyl group, e.g., Me, Et, iBu, Oct, in the form of either monomer or dimer that is not chemically bound to the aluminoxane structure. Although the free alkylaluminium can exchange with the coordinated alkylaluminum on the aluminoxane structure to become coordinated, the regeneration of the free alkylaluminum from the originally coordinated alkylaluminum maintains the free alkylaluminum concentration under the same conditions.

The terms aluminoxane, alumoxane, alkylaluminoxane, and alkylalumoxane are used interchangeably.

Sometimes only alkylaluminum is used to represent free alkylaluminum, e.g., TMA means free TMA.

“Free” or “free of” means undetectable with the current analytical methods, such as NMR spectroscopy or a conventional wet titration method. “Low in” means 2 wt % or 2 mol % or less based on total same element in the system, e.g., low in free TMA means the Al weight (or mol) of the free TMA content is 2 wt % (or mol %) or less based on the total Al weight (or mol) in the MAO composition. In some embodiments, “free” or “free of” includes the “low in” description, e.g., TMA free MAO may indicate the Al weight or molar number of the free TMA content is 2 wt % or 2 mol % or less based on the total Al content in MAO.

For convenience, “F-MAO” means anion modified MAO free of or low in free TMA content and ionic MAO means cation modified MAO free of or low in free TMA content.

“Electron-withdrawing group” is a group X on a compound capable of reacting with an aluminum alkyl compounds to form the AlR₂X compound in-situ, where R═C₁-C₈ is a hydrocarbyl group, that is capable of replacing the coordinated alkylaluminum in an alkylaluminoxane composition to completely or partially block the coordinated and free alkylaluminum equilibrium in a solution of an alkylaluminoxane, so-called a coordinated and free alkylaluminum equilibrium blocking agent. Examples of X include but are not limited to F, C₆F₅, OC₆F₅, and the like. The term “electron withdrawing compound” therefore may refer to a compound containing at least one electron-withdrawing group X capable of reacting with an aluminum alkyl compounds to form the AlR₂X compound, where R═C₁-C₈ hydrocarbyl group, that is capable of replacing the coordinated alkylaluminum, such as coordinated TMA in MAO to completely or partially block the coordinated and free TMA equilibrium in the solution of MAO, so-called a coordinated and free TMA equilibrium blocking agent. For examples, (NH₄)₂SiF₆, SiF₄, HOC₆F₅ and the like can be used to react with AlMe₃, AlEt₃, AlOct₃ to in-situ form AlMe₂F, AlEt₂F, AlOct₂F, AlMe₂(OC₆F₅), AlEt₂(OC₆F₅), and AlOct₂(OC₆F₅), respectively, in an MAO composition.

“Chelating agent or compound” means a compound with multiple donor groups to form a chelating structure with a dialkylaluminum cation in an alkylaluminoxane system. The preferred chelating agent or compound contains multiple siloxy donor groups, e.g., octamethyltrisiloxane (OMTS). Examples of chelating agents include but are not limited to linear or cyclic polysiloxanes, such as octamethyltrisiloxane (OMTS), octamethylcyclotetrasiloxane, decamethyltetrasiloxane, hexamethylcyclotrisiloxane, hexaphenylcyclotrisiloxane, and the like.

“Monodentate agent or compound” means a compound with a single donor group to form a non-chelating structure with a dialkylaluminum cation, in an alkylaluminoxane system. Examples of monodentate agent include but are not limited to compounds having a siloxy donor group containing a single oxygen such as hexamethyl disiloxane, hexaphenyldisiloxane, hexaethyldisiloxane, dimethylaluminum trimethylsiloxide, diethylaluminum triethylsiloxide, and the like; more preferred monodentate agents are siloxy donor group modified alkylaluminums, such as dimethylaluminum trimethylsiloxide, diethylaluminum trimethylsiloxide, diisobutylaluminum trimethylsiloxide, dimethylaluminum triethylsiloxide, diethylaluminum triethylsiloxide, diisobutylaluminum triethylsiloxide, dimethylaluminum tripropylsiloxide, diethylaluminum tripropylsiloxide, diisobutylaluminum tripropylsiloxide, dimethylaluminum triphenylsiloxide, diethylaluminum triphenylsiloxide, diisobutylaluminum triphenylylsiloxide, and the like; the most preferred monodentate agents are those from the in-situ generation through the decomposition of chelating agent treated MAO compositions, such as an OMTS treated MAO is heated to produce dimethylaluminum trimethylsiloxide as shown in Scheme 4 from I-b to I-a.

An “olefin,” alternatively referred to as “alkene,” is a linear, branched, or cyclic compound of carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. Accordingly, the definition of copolymer, as used herein, includes terpolymers and the like. “Different” as used to refer to mer units indicates that the mer units differ from each other by at least one atom or are different isomerically. An “ethylene polymer” or “ethylene copolymer” is a polymer or copolymer comprising at least 50 mol % ethylene derived units, a “propylene polymer” or “propylene copolymer” is a polymer or copolymer comprising at least 50 mol % propylene derived units, and so on.

Ethylene shall be considered an α-olefin.

Unless otherwise specified, the term “Cₙ” means hydrocarbon(s) having n carbon atom(s) per molecule, wherein n is a positive integer.

The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n. Likewise, a “Cₘ-C_{y}” group or compound refers to a group or compound comprising carbon atoms at a total number thereof in the range from m to y. Thus, a C₁-C₅₀ alkyl group refers to an alkyl group comprising carbon atoms at a total number thereof in the range from 1 to 50.

The terms “group,” “radical,” and “substituent” may be used interchangeably.

The terms “hydrocarbyl radical,” “hydrocarbyl group,” or “hydrocarbyl” may be used interchangeably and are defined to mean a group consisting of hydrogen and carbon atoms only. Hydrocarbyls may be C₁-C₁₀₀ radicals that may be linear, branched, or cyclic, and when cyclic, aromatic or non-aromatic. Examples of such radicals include, but are not limited to, alkyl groups such as methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, and the like, aryl groups, such as phenyl, benzyl, naphthalenyl, and the like.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halide (such as Br, C₁, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halide, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “aryl” or “aryl group” means an aromatic ring and the substituted variants thereof, such as phenyl, 2-methyl-phenyl, xylyl, 4-bromo-xylyl. Likewise, “heteroaryl” means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise, the term aromatic also refers to substituted aromatics.

The term “substituted aromatic,” means an aromatic group having 1 or more hydrogen groups replaced by a hydrocarbyl, substituted hydrocarbyl, heteroatom or heteroatom containing group.

A “substituted phenolate” is a phenolate group where at least one, two, three, four or five hydrogen atoms in the 2, 3, 4, 5, and/or 6 positions has been replaced with at least one non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), where the 1 position is the phenolate group (Ph-O—, Ph-S—, and Ph-N(R\hat{ })— groups, where R\hat{ } is hydrogen, C₁-C₄₀ hydrocarbyl, C₁-C₄₀ substituted hydrocarbyl, a heteroatom or a heteroatom-containing group). For example, a “substituted phenolate” group in the catalyst compounds described herein is represented by the formula:

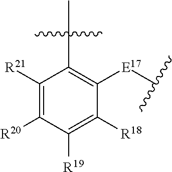

where R¹⁸ is hydrogen, C₁-C₄₀ hydrocarbyl (such as C₁-C₄₀ alkyl) or C₁-C₄₀ substituted hydrocarbyl, a heteroatom or a heteroatom-containing group, E¹⁷ is oxygen, sulfur, or NR¹⁷, and each of R⁷, R¹⁹, R²⁰, and R²¹ is independently selected from hydrogen, C₁-C₄₀ hydrocarbyl (such as C₁-C₄₀ alkyl) or C₁-C₄₀ substituted hydrocarbyl, a heteroatom or a heteroatom-containing group, or two or more of R¹⁸, R¹⁹, R²⁰, and R²¹ are joined together to form a C₄-C₆₂ cyclic or polycyclic ring structure, or a combination thereof, and the wavy line shows where the substituted phenolate group forms bonds to the rest of the catalyst compound. At least one of R¹⁸, R¹⁹, R²⁰, and/or R²¹ is not hydrogen.

An “alkyl substituted phenolate” is a phenolate group where at least one, two, three, four or five hydrogen atoms in the 2, 3, 4, 5, and/or 6 positions has been replaced with at least one alkyl group, such as a C₁ to C₄₀, alternately C₂ to C₂₀, alternately C₃ to C₁₂ alkyl, such as methyl, ethyl, methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, adamantyl and the like including their substituted analogues.

An “aryl substituted phenolate” is a phenolate group where at least one, two, three, four or five hydrogen atoms in the 2, 3, 4, 5, and/or 6 positions has been replaced with at least one aryl group, such as a C₁ to C₄₀, alternately C₂ to C₂₀, alternately C₃ to C₁₂ aryl group, such as phenyl, 4-fluorophenyl, 2-methylphenyl, 2-propylphenyl, 2,6-dimethylphenyl, mesityl, 2-ethylphenyl, naphthalenyl, and the like including their substituted analogues.

The term “ring atom” means an atom that is part of a cyclic ring structure. By this definition, a benzyl group has six ring atoms and tetrahydrofuran has 5 ring atoms.

A heterocyclic ring, also referred to as a heterocycle, is a ring having a heteroatom in the ring structure as opposed to a “heteroatom-substituted ring” where a hydrogen on a ring atom is replaced with a heteroatom. For example, tetrahydrofuran is a heterocyclic ring and 4-N,N-dimethylamino-phenyl is a heteroatom substituted ring. A substituted heterocyclic ring means a heterocyclic ring having 1 or more hydrogen groups replaced by a hydrocarbyl, substituted hydrocarbyl, heteroatom or heteroatom containing group.

A substituted hydrocarbyl ring means a ring comprised of carbon and hydrogen atoms having 1 or more hydrogen groups replaced by a hydrocarbyl, substituted hydrocarbyl, heteroatom or heteroatom containing group.

For purposes of the present disclosure, in relation to catalyst compounds (e.g., substituted bis(phenolate) catalyst compounds), the term “substituted” means that a hydrogen group has been replaced with a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

A tertiary hydrocarbyl group possesses a carbon atom bonded to three other carbon atoms. When the hydrocarbyl group is an alkyl group, tertiary hydrocarbyl groups are also referred to as tertiary alkyl groups. Examples of tertiary hydrocarbyl groups include tert-butyl, 2-methylbutan-2-yl, 2-methylhexan-2-yl, 2-phenylpropan-2-yl, 2-cyclohexylpropan-2-yl, 1-methylcyclohexyl, 1-adamantyl, bicyclo[2.2.1]heptan-1-yl and the like. Tertiary hydrocarbyl groups can be illustrated by the formula:

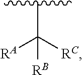

wherein R^{A}, R^{B} and R^{C} are independently hydrocarbyl groups or substituted hydrocarbyl groups that may optionally be bonded to one another, and the wavy line shows where the tertiary hydrocarbyl group forms bonds to other groups.

A tertiary hydrocarbyl group can be a cyclic tertiary hydrocarbyl group. Cyclic tertiary hydrocarbyl group is defined as a tertiary hydrocarbyl group that forms at least one alicyclic (non-aromatic) ring. Cyclic tertiary hydrocarbyl groups are also referred to as alicyclic tertiary hydrocarbyl groups. When the hydrocarbyl group is an alkyl group, cyclic tertiary hydrocarbyl groups are also referred to as cyclic tertiary alkyl groups or alicyclic tertiary alkyl groups. Examples of cyclic tertiary hydrocarbyl groups include 1-adamantyl, 1-methylcyclohexyl, 1-methylcyclopentyl, 1-methylcyclooctyl, 1-methylcyclodecyl, 1-methylcyclododecyl, bicyclo[3.3.1]nonan-1-yl, bicyclo[2.2.1]heptan-1-yl, bicyclo[2.3.3]hexan-1-yl, bicycle[1.1.1]pentan-1-yl, bicycle[2.2.2]octan-1-yl, and the like. Cyclic tertiary hydrocarbyl groups can be illustrated by Formula (B):

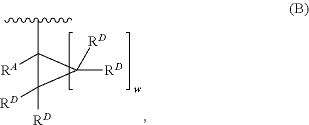

wherein R^{A} is a hydrocarbyl group or substituted hydrocarbyl group, each R^{D} is independently hydrogen or a hydrocarbyl group or substituted hydrocarbyl group, w is an integer from 1 to about 30, and R^{A}, and one or more R^{D}, and or two or more R^{D} may optionally be bonded to one another to form additional rings.

When a cyclic tertiary hydrocarbyl group contains more than one alicyclic ring, it can be referred to as polycyclic tertiary hydrocarbyl group or if the hydrocarbyl group is an alkyl group, it may be referred to as a polycyclic tertiary alkyl group.

The terms “alkyl radical” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like including their substituted analogues. Substituted alkyl radicals are radicals in which at least one hydrogen atom of the alkyl radical has been substituted with at least a non-hydrogen group, such as a hydrocarbyl group, a heteroatom or heteroatom-containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, and the like, where each R* is independently hydrogen, a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol (g mol⁻¹).

The following abbreviations may be used herein: Me is methyl, Et is ethyl, ⁱBu is isobutyl, Oct is octyl, MAO is methylaluminoxane, Bn is benzyl (i.e., CH₂Ph), THF (also referred to as thf) is tetrahydrofuran, RT is room temperature (and is 23° C. unless otherwise indicated), tol is toluene, Cp is cyclopentadienyl, NMR is nuclear magnetic resonance, and TMA is trimethylaluminum.

A “catalyst system” is a combination of at least one catalyst compound, an activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators (including support-bound activators) represented by formulae herein embrace both neutral and ionic forms of the catalyst compounds and activators.

In the description herein, the catalyst may be described as a catalyst, a catalyst precursor, a pre-catalyst compound, catalyst compound or a transition metal compound, and these terms are used interchangeably.

An “anionic ligand” is a negatively charged ligand which donates one or more pairs of electrons to a metal ion. The term “anionic donor” is used interchangeably with “anionic ligand”. Examples of anionic donors may include, but are not limited to, methyl, chloride, fluoride, alkoxide, aryloxide, alkyl, alkenyl, thiolate, carboxylate, amido, benzyl, hydrido, amidinate, amidate, and phenyl. Two anionic donors may be joined to form a dianionic group.

A “neutral Lewis base” or “neutral donor group” is an uncharged (neutral) group which donates one or more pairs of electrons to a metal ion. Non-limiting examples of neutral Lewis bases include ethers, thioethers, amines, phosphines, ethyl ether, tetrahydrofuran, dimethylsulfide, triethylamine, pyridine, alkenes, alkynes, alenes, and carbenes. Lewis bases may be joined together to form bidentate or tridentate Lewis bases.

For purposes of the present disclosure and the claims thereto, phenolate donors can include Ph-O—, Ph-S—, and Ph-N(R**)— groups, where R** is hydrogen, C₁-C₄₀ hydrocarbyl, C₁-C₄₀ substituted hydrocarbyl, a heteroatom or a heteroatom-containing group, and Ph is optionally substituted phenyl.

The present disclosure relates to catalyst systems of the present disclosure having bis(phenolate)-type catalysts based on rare earth elements in combination with alkylaluminum-free aluminoxane (e.g. TMA-free aluminoxane), wherein alkylaluminum-free aluminoxane is defined to have 0 wt % to about 2 wt % Al from non-coordinated trialkylaluminum compound based on total Al metal weight in the system, that can be used for producing copolymers of ethylene and butadiene under mild conditions with high conversions. Such improved catalyst systems provide complimentary catalyst-activator pairs that provide polymerizing mono-olefins and conjugated dienes at high activity (e.g., within the same process window) to provide commercially scalable polymerizations (e.g., high activity under mild conditions). The catalyst systems of the present disclosure are attractive options for implementation into industrial scale processes for the high throughput production of copolymer materials, e.g., derived from ethylene and butadiene monomers, having tailorable physical properties, polymer backbone architecture, and varying functional moieties. In addition, polar side chain moieties can be incorporated into the polymer chains over the course of copolymerization. Such functionalized polymers can be desirable for the tire industry due to enhanced interactions between the copolymer and filler(s) present with the copolymer during use as a tire material.

In addition, the copolymers formed using catalyst systems of the present disclosure can have a plurality of 1,2-cyclopentane units distributed along the polymer backbone. These units can be distributed substantially uniformly across the polymer backbone which prevents crystallinity (e.g., polyethylene blocks). Without being bound by theory, the 1,2-cyclopentane units distributed substantially uniformly across the polymer backbone can disrupt intra- and inter-chain interactions thereby decreasing the ability of the polymer system to crystallize (as evidenced by lower Tm values as compared to polyethylene homopolymer). Activators of the present disclosure can provide copolymers having higher content of 1,2-cyclopentane units than copolymers prepared using conventional activators. 1,2-cyclopentane units can provide increased stiffness to copolymers which can be beneficial for use of the copolymers in tires.

This present disclosure relates to a catalyst system comprising:
1) an anion modified alkylaluminoxane, and/or
a cation modified alkylaluminoxane, wherein the alkylaluminoxane composition has 0 wt % to about 2 wt % of non-coordinated trialkylaluminum compound, based on total aluminum content of the alkylaluminoxane composition as determined by titration of the alkylaluminoxane composition with tetrahydrofuran; and
2) a compound represented by Formula (I):

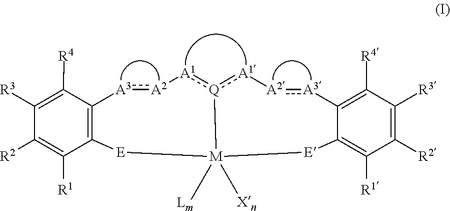

wherein:
M of is a group 3 transition metal or a lanthanide metal;
E and E′ are each independently oxygen, sulfur, or NR^{A}, wherein R^{A} is independently hydrogen, C₁-C₄₀ hydrocarbyl, substituted C₁-C₄₀ hydrocarbyl, or a heteroatom-containing group;
Q of is a group 14 atom, group 15 atom, or group 16 atom;
A¹QA^{1′} are part of a heterocyclic Lewis base containing 4 to 40 non-hydrogen atoms that links A² to A^{2′} via a 3-atom bridge with Q being central atom of the 3-atom bridge;
   each of A¹ and A^{1′} is independently carbon, nitrogen, or C(R^{B}), wherein R^{B} is selected from hydrogen, C₁-C₂₀ hydrocarbyl, and substituted C₁-C₂₀ hydrocarbyl;

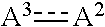

is a divalent group containing 2 to 40 non-hydrogen atoms that links A¹ to the E-bonded aryl group shown in Formula (I) via a 2-atom bridge, and A³ and A² are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings;

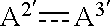

is a divalent group containing 2 to 40 non-hydrogen atoms that links A^{1′} to the E′-bonded aryl group shown in Formula (I) via a 2-atom bridge, and A^{3′} and A² are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings;
each L is independently a Lewis base;
X′ is an anionic ligand;
any two L groups may be joined together to form a bidentate Lewis base;
an X′ group may be joined to an L group to form a monoanionic bidentate group;
n is 1;
m is 0, 1, or 2;
n+m is not greater than 3; and
   each of R¹, R², R³, R⁴, R¹, R^{2′}, R^{3′}, and R^{4′} is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R¹ and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In some embodiments, the present disclosure relates to methods of polymerizing olefins using catalyst systems having a trialkylaluminum free alkylaluminoxane composition, wherein the trialkylaluminum free alkylaluminoxane composition means that the free trialkylaluminum content in the alkylaluminoxane composition is zero or near zero, e.g., 2 wt % or 2 mol % or less, while the alkylalumoxane active sites capable of providing Al(alkyl)₂⁺ are maintained or increased through the treatment of an anion modification agent or a cation modification agent. Unlike physical removal of free trialkylaluminum in alkylaluminoxane that causes the loss of catalyst activity, the trialkylaluminum free active alkylaluminoxane composition produced via an anion modification agent or a cation modification agent maintains or improves catalyst activity for a wide range of pre-catalysts. Without being bound by theory, it is believed that either the anion modification agent (e.g., (NH₄)₂SiF₆) or the cation modification agent (e.g., OMTS) treated alkylaluminoxane solution either converts total trialkylaluminum to Al(alkyl)₂X (X=electron-withdrawing group) capable of replacing coordinated trialkylaluminum to eliminate the coordinated and free trialkylaluminum equilibrium, or enables the ionization of the alkylalumoxane to precipitate as a clathrate phase to enable the physical separation from free trialkylaluminum. Free trialkylaluminum is also referred to as non-coordinated alkylaluminum, or non-coordinated trialkylaluminum.

In some embodiments, the present disclosure relates to methods of polymerizing olefins using catalyst systems having TMA free alkylaluminoxane compositions including TMA free MAO, wherein TMA free MAO means that the free TMA content in MAO is zero or near zero, e.g., 2 wt % or 2 mol % or less, while the MAO active sites capable of providing AlMe₂⁺ are maintained or increased through the treatment of an anion modification agent or a cation modification agent. Unlike physical removal of free TMA in MAO that causes the loss of activity, the TMA free active MAO composition produced via an anion modification agent or a cation modification agent maintains or improves catalyst activity for a wide range of pre-catalysts. Without being bound by theory, it is believed that either the anion modification agent (e.g., (NH₄)₂SiF₆, illustrated as Si—F in Scheme 4) or the cation modification agent (e.g., OMTS) treated MAO solution either converts total TMA to AlMe₂X (X=electron-withdrawing group which is F in Scheme 4) capable of replacing coordinated TMA to eliminate the coordinated and free TMA equilibrium (see Scheme 1), or enables the ionization of the MAO composition to precipitate as a clathrate phase to enable the physical separation from free TMA (Scheme 4). Free TMA is also referred to as non-coordinated TMA.

In some embodiments, a method of making an anion modified alkylaluminoxane (also called trialklyaluminum free alkylaluminoxane) includes the treatment of an alkylaluminoxane solution, with an anion modification agent such as an electron withdrawing compound that is capable of converting the total trialkylaluminum (free and coordinated trialkylaluminum) to Al(alkyl)₂X (X=electron-withdrawing group) as the major derivative and an optional minor non-fluorinated inert aluminumalkyl derivative, depending on the electron withdrawing compound structure in use. The anion modified alkylaluminoxane comprises the electron withdrawing group, X.

In some embodiments, a method of making an anion modified alkylaluminoxane includes introducing an alkylaluminoxane composition containing free trialkylaluminum and coordinated trialkylaluminum, and a fluorine containing compound capable of converting the majority of both free and coordinated trialkylaluminum to Al(alkyl)₂F or Al(alkyl)₂(OC₆F₅) to form a modified alkylaluminoxane composition free of or low in free trialkylaluminum content. The anion modified alkylaluminoxane comprises the electron withdrawing group, and the electron withdrawing group comprises an F, or OC₆F₅ group.

In some embodiments, a method of making a TMA free MAO (also called anion modified MAO) includes the treatment of a MAO solution, with an anion modification agent such as an electron withdrawing compound capable of converting the total TMA (free and coordinated TMA) to AlMe₂X (X=electron-withdrawing group) as the major derivative and an optional minor non-fluorinated inert aluminumalkyl derivative, depending on the electron withdrawing compound structure in use. The TMA free MAO comprises the electron withdrawing group, X.

In some embodiments, a method of making a TMA free solution MAO composition includes introducing a solution MAO composition containing free TMA and coordinated TMA and a fluorine containing compound capable of converting the majority of both free and coordinated TMA to AlMe₂F or AlMe₂(OC₆F₅) to form an anion modified MAO composition free of or low in free TMA content. The TMA free MAO comprises the electron withdrawing group, and the electron withdrawing group comprises an F or OC₆F₅ group.

In some embodiments, a method of making a cation modified alkylaluminoxane (also called trialklyaluminum free alkylaluminoxane) includes the treatment of alkylaluminoxane solution with a cation modification agent such as a chelating or monodenate agent to form an ionic alkylaluminoxane composition, followed by a physical separation process to isolate the majority of free trialkylaluminum content, and a heating process to partially or completely convert the chelating ligand to monodentate ligand(s) with optional additional free alkylaluminum charge. The cation modified alkylaluminoxane comprises a portion of the chelating agent.

In some embodiments, a method of making cation modified alkylaluminoxane includes the treatment of alkylaluminoxane solution with a cation modification agent such as a OMTS to form an ionic alkylaluminoxane composition, followed by a physical separation process to isolate the majority of free trialkylaluminum content, e.g., through a phase separation, and heating the clathrate phase to partially or completely convert the OMTS ligand to dialkylaluminum trimethylsiloxide with residual free trialkylaluminum or an additional amount of free trialkylaluminum. The cation modified alkylaluminoxane comprises a portion of the chelating agent, and the chelating agent comprises a siloxy donor such as dimethylaluminum trialkylsiloxide.

In some embodiments, a method of making a TMA free MAO (also called cation modified MAO) includes the treatment of solution MAO with a chelating or monodenate agent to form an ionic MAO composition, followed by a physical separation process to isolate the majority of free TMA content and a heating process to partially or completely convert the chelating ligand to monodentate ligand(s) with optional additional free alkylaluminum charges such as trimethylaluminum, triethylaluminum, or triisobutylaluminum.

In some embodiments, a method of making a TMA free MAO includes the treatment of solution MAO with a OMTS to form an ionic MAO composition, followed by a physical separation process to isolate the majority of free TMA content, e.g., through a phase separation, and heating the clathrate phase to partially or completely convert the OMTS ligand to trimethylsiloxy ligand with residual free TMA or an additional amount of free TMA as shown in Scheme 4. The TMA free MAO comprises a portion of the chelating agent, and the chelating agent comprises a siloxy donor such as dimethylaluminum trimethylsiloxide.

In some embodiments, the present disclosure provides a polymerization process including contacting one or more olefin monomers with a pre-catalyst of the present disclosure.

### Formation of Non-Coordinated Alkylaluminum Free Activator Systems

As described above, non-coordinated alkylaluminum (or free alkylaluminum) where “free” includes the “low in” description, e.g., TMA free MAO may indicate the Al weight or molar number of the free TMA content is 2 wt % or 2 mol % or less based on the total Al content in MAO, with the free alkylaluminum quantification method described in the experimental section. Such non-coordinated alkylaluminum free systems may be made from either the two methods described or both below:

### A) In-Situ Anion Modified Aluminoxane, Also Called Anion Modified Aluminoxane

A regular MAO solution, e.g., W. R. Grace 30% MAO product containing free TMA, can be treated with an electron-withdrawing compound to introduce an electron-withdrawing group to the MAO composition while removing the free TMA by converting it into AlMe₂X (X=electron-withdrawing group) and replacing the coordinated TMA while still maintaining the coordinated TMA function, i.e., providing AlMe₂⁺ as the activator, as shown in Scheme 4 I-c. The electron-withdrawing compound can therefore be also called an anion modification agent. As Scheme 4 indicates, strong electron withdrawing compounds, e.g., compounds containing reactive strong electron withdrawing atom(s) or group(s) such as fluorine atom containing compounds or a pentafluorophenoxy (C₆F₅O—) containing compounds, have been found to be capable of converting the free TMA in MAO in-situ to AlMe₂F or AlMe₂(OC₆F₅) that can serve as a coordinated and free TMA equilibrium blocking agent (TEB agent). The TEB agent is able to replace the coordinated TMA (which becomes free TMA) therefore eliminating the coordinated TMA to free TMA equilibrium, as well as providing more AlMe₂⁺ for pre-catalyst ionization, and a more dispersed MAO anion charge to weaken the active ion-pair interaction due to the introduction of the strong electron withdrawing atoms or groups on the MAO anions (as shown in Scheme 4). The overall result is the removal the free TMA and an increase the catalyst system's activity. The total TMA in MAO to TEB agent conversion is therefore a much more efficient method to remove the free TMA in MAO while maintaining or improving the activation efficiency to obtain a system that is suitable to activate pre-catalysts built with ligands containing TMA reactive hetero-atom donors, e.g., N, O, S, and/or P donors such as in ligands for post-metallocene pre-catalysts. The quantification method for total TMA in an MAO composition is described in the Experimental section.

In some embodiments, the electron withdrawing compound is an inorganic compound having the formula (A′):

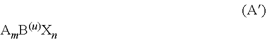

where A shown in Formula (A′) is a cation; m is 0, 1, or 2, provided that when m is 0, B is H, or a group 3, 4, 5, 6, 7, 13, 14, 15, 16, or 17 element, and when m is not zero, B is a group 3, 4, 5, 13, 14, or 15 element; u is the valence state of element B; X is an electron withdrawing atom or group; and n=m+u.

In some embodiments, the inorganic fluorine containing compound having the formula (A′) is selected from NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, B(OC₆F₅)₃, AlF₃, Al(OC₆F₅)₃, NHF₂ and NH₄HF₂. Of these, ammonium hexafluorosilicate may be preferred due to its high fluorination efficiency.

In some embodiments, the electron withdrawing compound is an organometallic compound having the formula (B′):

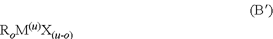

where R is a C₁ to C₁₀ hydrocarbyl group; M is a group 13 or 14 element; when M is Al of the group 13 element, o is 1; when M is a non-Al group 13 element, o is 1 or 2; and when M is a group 14 element, o is 1, 2, or 3; X is an electron withdrawing atom or group; and u is the valence state of element M.

In some embodiments, the organic fluorine compound having the formula (B′) is selected from Me₃SiF, Me₂SiF₂, MeSiF₃, Et₃SiF, Et₂SiF₂, EtSiF₃, Ph₃SiF, Ph₂SiF₂, PhSiF₃, Me₃CF, Me₂CF₂, MeCF₃, Et₃CF, Et₂CF₂, EtCF₃, Ph₃CF, Ph₂CF₂, PhCF₃, Me₂BF, MeBF₂, MeAlF₂, Et₂BF, EtBF₂, EtAlF₂, Ph₂BF, PhBF₂, Me₃Si(OC₆F₅), Me₂Si(OC₆F₅)₂, MeSi(OC₆F₅)₃, Me₃C(OC₆F₅), Ph₃C(OC₆F₅), Me₂B(OC₆F₅), MeB(OC₆F₅)₂, MeAl(OC₆F₅)₂.

In some embodiments, the anion modified alkylaluminoxane (including anion modified MAO) comprises the electron withdrawing group, and the electron withdrawing group comprises —F or —OC₆F₅.

### B) Cation Modified Aluminoxanes, Also Called Ionic Aluminoxanes

Chelating agents such as polysiloxanes or monodenate agents such as silanols as well as the derived dialkylaluminum siloxides may be used as cation modification agents to produce the non-coordinated trialkylaluminum free aluminoxane composition. A chelating agent such as OMTS can precipitate the aluminoxane such as MAO as an ionic aluminoxane (e.g., a clathrate) to allow its separation from free alkylaluminum. A variety of organic or organometallic compounds may be suitable in forming an ionic aluminoxane to allow the separation with free alkylaluminum. In some embodiments, a variety of aluminoxanes can be used in forming stable ionic alkylaluminoxanes, such as methylaluminoxane. In forming the stable ionic aluminoxane, the denser lower liquid phase (or the clathrate phase) may be readily separated from the upper solution phase by conventional separation techniques such as by phase cut, decantation, or draining.

Chelating agent derived ionic MAO: In some embodiments, a starting material may be a chelating agent dissolved in a hydrocarbon solvent such as an aromatic solvent. For example, starting materials may include a hydrocarbylaluminoxane, e.g., an alkylaluminoxane, and a chelating agent that is a hydrocarbylpolysiloxane, such as a hydrocarbyltrisiloxane. In some embodiments, a chelating hydrocarbylpolysilyloxane compound can have at least three silicon atoms in the molecule, which are separated from each other by an oxygen atom such that there is a linear, branched, or cyclic backbone of alternating Si and oxygen atoms, with the remainder of the four valence bonds of each of the silicon atoms individually satisfied by a univalent hydrocarbyl group. The hydrocarbylpolysiloxane may have as many as 18 or more silicon atoms in the molecule. The univalent hydrocarbyl groups of the polysiloxane may each contain, independently, up to about 18 carbon atoms, and can be such groups as alkyl, cycloalkyl, aryl, arylalkyl, etc.

In some embodiments, a chelating agent may include a polydentate siloxane having the formula R(SiR₂O)ₙSiR₃ where each R is independently hydrogen, alkyl (e.g., methyl, ethyl, propyl, butyl, pentyl, hexyl, heptyl, octyl, nonyl, or decyl), alkenyl, aryl, or a heteroatom substituted hydrocarbyl group and n=2-8. In some embodiments, each R is methyl. In some embodiments, the chelating agent may include a cyclic polydentate siloxane having the formula (SiR₂O)ₙ, where R is independently hydrogen, alkyl (e.g., methyl, ethyl, propyl, butyl, pentyl, hexyl, heptyl, octyl, nonyl, or decyl), alkenyl, aryl, or a heteroatom substituted hydrocarbyl group and n=3-6.

Non-limiting examples of such polysiloxanes include hexamethylcyclotrisiloxane, octamethylcyclotetrasiloxane, octaphenylcyclotetrasiloxane, octamethyltrisiloxane (OMTS), decamethyltetrasiloxane, dodecamethylpentasiloxane, tetradecamethylhexasiloxane, 2,4,6,8-tetramethyl-2,4,6,8-tetravinylcyclotetrasiloxane (as an example of alkenyl substituent on the polydentate compound), and 1,3,5,7-tetrakis(3,3,3-trifluoropropyl)1,3,5,7-tetramethylcyclosiloxanes (as an example of heteroatom containing substituent on the polydentate compound).

In some embodiments, the ionic alkylaluminoxane, e.g., ionic MAO, containing the dialkylaluminum cation stabilized by the chelating ligand, e.g., [AlMe₂(OMTS)]⁺, can be heated to become more active, presumably by forming the less stable monodentate complex after heating readily to release dialkylaluminum cation, e.g., AlMe₂⁺, as the siloxy (trimethylsiloxy) group containing structure I-a observed by ¹H-NMR spectroscopy:

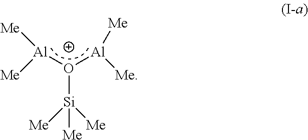

The heating temperature may be about 40° C. to about 130° C., such as about 60° C. to about 110° C., such as about 80° C. to about 100° C. The heating time can be about 30 minutes to about 24 hours, such as about 2 hours to about 12 hours, such as about 4 hours to about 8 hours. Aging at ambient may also decompose the chelating complex to increase the activation efficiency, but would take much longer time, e.g., 24 hr, 2 days, or 1 week, or longer.

Monodentate agent derived ionic MAO: Alternatively, the ionic aluminoxane may be formed by using a silanol SiR₃OH to convert free alkylaluminum in alkylaluminoxane in-situ, such as TMA in an MAO composition, to form a monodentate coordination compound R₃SiOAlR₂ (e.g., R=Me) to serve as a dialkylaluminum cation stabilization agent as well as to eliminate or reduce the free alkylaluminum, which is desired for a solution aluminoxane system due to challenging process to remove free alkylaluminum in a solution system. The R group of silanols having formula HO—SiR₃ is independently hydrogen, alkyl (e.g., methyl, ethyl, propyl, butyl, pentyl, hexyl, heptyl, octyl, nonyl, or decyl), alkenyl, aryl, or a heteroatom containing group. In some embodiments, each of R is methyl. The heating process is optional for monodentate agent treatment.

### Pre-Catalyst Compounds

The terms “catalyst”, “catalyst compound”, “catalyst complex”, “transition metal complex”, “transition metal compound”, “precatalyst compound”, and “precatalyst complex” are used interchangeably to describe a transition metal or lanthanide metal complex that forms an olefin polymerization catalyst when combined with a suitable activator.

In at least one embodiment, the present disclosure provides a catalyst system comprising a catalyst compound having a metal atom. The catalyst compound can be a metallocene catalyst compound. The metal can be a group 3 transition metal, or lanthanide metal. The catalyst compound can be a group 3 transition metal, or lanthanide metal with a monodentate or multidentate ligand, such as bidentate, tridentate, or tetradentate ligand, where a heteroatom of the catalyst, such as phosphorous, oxygen, nitrogen, or sulfur is chelated to the metal atom of the catalyst. Non-limiting examples include bis(phenolate)s. In at least one embodiment, a group 3 transition metal or lanthanide metal atom is selected from Sc, Y, and La.

Catalysts of the present disclosure can be “post-metallocene” catalysts having an oxygen and/or nitrogen atom(s). For example, a catalyst of the present disclosure can be a metal complex having: a metal selected from group 3 or lanthanide metals, and a tridentate, dianionic ligand containing two anionic donor groups and a neutral Lewis base donor, where the neutral Lewis base donor is covalently bonded between the two anionic donors, and where the metal-ligand complex features a pair of 8-membered metallocycle rings.

The catalyst complexes of the present disclosure include a metal selected from group 3 or lanthanide metals of the Periodic Table of the Elements, a tridentate dianionic ligand containing two anionic donor groups and a neutral heterocyclic Lewis base donor, wherein the heterocyclic donor is covalently bonded between the two anionic donors. In some embodiments, the dianionic, tridentate ligand features a central heterocyclic donor group and two phenolate donors and the tridentate ligand coordinates to the metal center to form two eight-membered rings.

In some embodiments, the heterocyclic Lewis base donor of the catalyst compound features a nitrogen or oxygen donor atom. For example, heterocyclic groups include derivatives of pyridine, pyrazine, pyrimidine, triazine, thiazole, imidazole, thiophene, oxazole, thiazole, furan, and substituted variants of thereof. In some embodiments, the heterocyclic Lewis base lacks hydrogen(s) in the position alpha to the donor atom. In some embodiments, a heterocyclic Lewis base donor includes pyridine, 3-substituted pyridines, and 4-substituted pyridines.

The anionic donors of the tridentate dianionic ligand may be arylthiolates, phenolates, or anilides. In some embodiments, anionic donors are phenolates. The tridentate dianionic ligand coordinates to the metal center to form a complex that may lack a mirror plane of symmetry. In some embodiments, the tridentate dianionic ligand coordinates to the metal center to form a complex that has a two-fold rotation axis of symmetry; when determining the symmetry of the bis(phenolate) complexes only the metal and dianionic tridentate ligand are considered (i.e. ignore remaining ligands).

Catalyst compounds of the present disclosure can be bis(aryl phenolate)pyridine complexes. Bis(aryl phenolate)pyridine complexes may have a tridentate bis(aryl phenolate)pyridine ligand that is coordinated to a group 3 transition metal or lanthanide metal with the formation of two eight-membered rings. In some embodiments, a bis(aryl phenolate)pyridine complexes includes transition metal complexes of a dianionic, tridentate ligand that features a central neutral donor group and two phenolate donors, where the tridentate ligands coordinate to the metal center to form two eight-membered rings, for example, the post-metallocene catalyst can be an 8-8 catalyst. In complexes of this type, it is advantageous for the central neutral donor to be a heterocyclic group. It is advantageous for the heterocyclic group to lack hydrogens in the position alpha to the heteroatom.

In some embodiments, bis(phenolate) ligands can be tridentate dianionic ligands that coordinate to the metal M in such a fashion that a pair of 8-membered metallocycle rings are formed. The bis(phenolate) ligands wrap around the metal to form a complex with a 2-fold rotation axis, thus giving the complexes C₂ symmetry. The C₂ geometry and the 8-membered metallocycle rings are features of these complexes that make them effective catalyst components for the production of polyolefins.

Bis(phenolate), anilide, and/or arylthiolate ligands that contain donor groups (e.g., oxygen, nitrogen, or sulfur, respectively) can be substituted with alkyl, substituted alkyl, aryl, or other groups. It can be advantageous that each phenolate group be substituted in the ring position that is adjacent to the donor atom on the ring structure. For example, that substitution at the position adjacent to the donor atom can be an alkyl group containing 1-20 carbon atoms. In complexes of this type it may also be advantageous for the phenolates to be substituted with one or more alkyl substituents (e.g., ortho and/or para to the oxygen of the phenolate). In some embodiments, a substitution at the position next to the donor atom can be a non-aromatic cyclic alkyl group with one or more five- or six-membered rings. In complexes of this type it may also be advantageous for the phenolates to be substituted with one or more cyclic tertiary alkyl substituents. The use of cyclic tertiary alkyl substituted phenolates can improve the ability of these catalysts to produce high molecular weight polymer. In some embodiments, substitution at the position next to the oxygen donor atom is adamantan-1-yl or substituted adamantan-1-yl. In some embodiments, substitution at the position next to the oxygen donor atom is tert-butyl or substituted tert-butyl.

The neutral heterocyclic Lewis base donor is covalently bonded between the two anionic donors (e.g., between two phenolate groups) via “linker groups” that join the heterocyclic Lewis base to the anionic donors. For example, “linker groups” are indicated by (A³A²) and (A^{2′}A^{3′}) in Formula (I), described in more detail below. The choice of each linker group may affect the catalyst performance. Each linker group can be a C₂-C₄₀ divalent group that is two-atoms in length. One or both linker groups may independently be phenylene, substituted phenylene, heteroaryl, vinylene, or a non-cyclic two-carbon long linker group. In some embodiments, one or both phenylenes may be unsubstituted or may be independently substituted with C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments, a catalyst compound is represented by Formula (I):

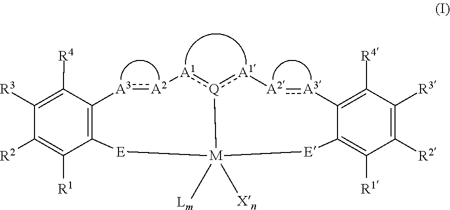

wherein:
M is a group 3 transition metal or a lanthanide metal (such as Sc, Y, or La);
E and E′ are each independently O, S, or NR^{A}, where R^{A} is independently hydrogen, C₁-C₄₀ hydrocarbyl, substituted C₁-C₄₀ hydrocarbyl, or a heteroatom-containing group, such as O, such as both E and E′ are O;
Q is group 14, 15, or 16 atom, such as Q is C, O, S, or N, such as Q is C, N, or O, such as Q is N;
A¹QA^{1′} are part of a heterocyclic Lewis base containing 4 to 40 non-hydrogen atoms that links A² to A^{2′} via a 3-atom bridge with Q being the central atom of the 3-atom bridge (A¹QA^{1′} combined with the curved line shown joining A¹ and A^{1′} represents the heterocyclic Lewis base);
each of A¹ and A^{1′} is independently C, N, or C(R^{B}), where R^{B} is selected from hydrogen, C₁-C₂₀ hydrocarbyl, and substituted C₁-C₂₀ hydrocarbyl (for example, each of A¹ and A^{1′} are C);

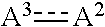

is a divalent group containing 2 to 40 non-hydrogen atoms that links A¹ to the E-bonded aryl group via a 2-atom bridge, and A³ and A² are combined to form a substituted hydrocarbyl ring, an unsubstituted hydrocarbyl ring, a substituted heterocyclic ring, or an unsubstituted heterocyclic rings each having 5, 6, 7, or 8 ring atoms, and where substitutions on the ring can join to form additional rings, such as A³ and A² are combined to form ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene;

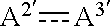

is a divalent group containing 2 to 40 non-hydrogen atoms that links A^{1′} to the E′-bonded aryl group via a 2-atom bridge, and A^{3′} and A^{2′} are combined to form a substituted hydrocarbyl ring, an unsubstituted hydrocarbyl ring, a substituted heterocyclic ring, or an unsubstituted heterocyclic rings each having 5, 6, 7, or 8 ring atoms, and where substitutions on the ring can join to form additional rings, such as A^{3′} and A^{2′} are combined to form, such as ortho-phenylene, substituted ortho-phenylene, ortho-arene, substituted ortho-arene, indolene, substituted indolene, benzothiophene, substituted benzothiophene, pyrrolene, substituted pyrrolene, thiophene, substituted thiophene;
each L is independently a Lewis base;
X′ is an anionic ligand;
any two L groups may be joined together to form a polydentate (e.g., bidentate) Lewis base;
an X′ group may be joined to an L group to form a monoanionic bidentate group;
n is 1;
m is 0, 1, or 2;
n+m is not greater than 3; and
each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group (such as R^{1′} and R¹ are independently a hydrocarbyl group, such as a tertiary alkyl group, or a cyclic hydrocarbyl group, such as a cyclic tertiary alkyl group), or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

The metal, M, is selected from group 3 elements or lanthanide elements. For example, the metal, M, is Sc, Y, or La.

The donor atom Q of the neutral heterocyclic Lewis base (in Formula (I)) can be nitrogen sulfur, or oxygen. In some embodiments, Q is nitrogen.

Non-limiting examples of neutral heterocyclic Lewis base groups include pyridine, pyrazine, pyrimidine, triazine, thiazole, imidazole, thiophene, oxazole, thiazole, furan, and substituted variants of thereof. In some embodiments, heterocyclic Lewis base groups can include pyridine, pyrazine, thiazole, or imidazole.

In some embodiments, each of A¹ and A^{1′} is independently C, N, or C(R²²), where R²² is selected from hydrogen, C₁-C₂₀ hydrocarbyl, and substituted C₁-C₂₀ hydrocarbyl. In some embodiments, each of Al and A^{1′} is carbon. When Q is carbon, each of Al and A^{1′} can be independently selected from nitrogen and C(R²²). When Q is nitrogen, each of A¹ and A^{1′} can be carbon. In some embodiments, Q=nitrogen and A¹=A^{1′}=carbon. When Q is nitrogen or oxygen, the heterocyclic Lewis base of Formula (I) might not have any hydrogen atoms bound to the A¹ or A^{1′} atoms, which may be preferred because it is thought that hydrogens in those positions may undergo unwanted decomposition reactions that reduce the stability of the catalytically active species.

In at least one embodiment of Formula (I), Q is carbon and each of A¹ and A^{1′} is N or C(R²²), where R²² is selected from hydrogen, C₁-C₂₀ hydrocarbyl, substituted C₁-C₂₀ hydrocarbyl, a heteroatom or a heteroatom-containing group. In such embodiments, the A¹QA^{1′} fragment forms part of a cyclic carbene, N-heterocyclic carbene, cyclic amino alkyl carbene, or a substituted variant thereof.

The heterocyclic Lewis base (of Formula (I)) represented by A¹QA^{1′} combined with the curved line joining A¹ and A^{1′} can be selected from the following, with each R²³ group selected from hydrogen, heteroatoms, C₁-C₂₀ alkyls, C₁-C₂₀ alkoxides, C₁-C₂₀ amides, and substituted C₁-C₂₀ alkyls.

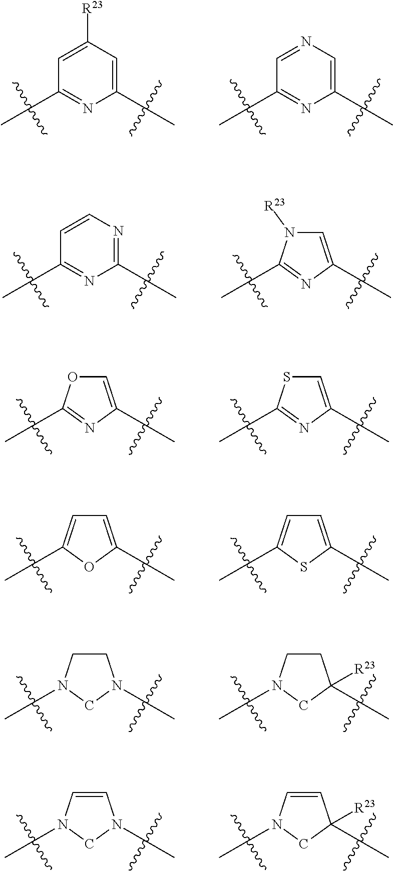

In some embodiments, the heterocyclic Lewis base (of Formula (I)) represented by A¹QA^{1′} combined with the curved line joining A¹ and A^{1′} is a six membered ring containing zero or one ring heteroatoms or a five membered ring containing zero, one two or three ring heteroatoms. Alternately, the heterocyclic Lewis base (of Formula (I)) represented by A¹QA^{1′} combined with the curved line joining A¹ and A^{1′} is not a six membered ring containing two or more ring heteroatoms.

In some embodiments of Formula (I), A¹QA^{1′} are part of a heterocyclic Lewis base containing 2 to 20 non-hydrogen atoms that links A² to A^{2′} via a 3-atom bridge with Q being the central atom of the 3-atom bridge. In some embodiments, each A¹ and A^{1′} is a carbon atom and the A¹QA^{1′} fragment forms part of a pyridine, pyrazine, pyrimidine, triazine, thiazole, imidazole, thiophene, oxazole, thiazole, furan, or a substituted variant of thereof group, or a substituted variant thereof.

In some embodiments of Formula (I), M is Sc, Y, or La, Q is nitrogen, both A¹ and A^{1′} are carbon, both E and E′ are oxygen, and both R¹ and R^{1′} are independently C₄-C₂₀ cyclic tertiary alkyl.

In some embodiments of Formula (I), M is Sc, Y, or La, Q is nitrogen, both A¹ and A^{1′} are carbon, both E and E′ are oxygen, and both R¹ and R^{1′} are independently adamantan-1-yl or substituted adamantan-1-yl.

In some embodiments of Formula (I), M is Sc, Y, or La, Q is nitrogen, both A¹ and A^{1′} are carbon, both E and E′ are oxygen, and both R¹ and R^{1′} are independently acyclic tertiary alkyl.

In some embodiments, a catalyst compound is represented by Formula (II):

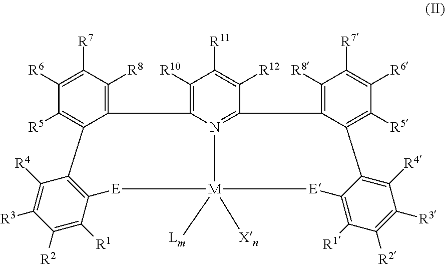

wherein:
M is a group 3 metal or a lanthanide metal (such as Sc, Y, or La);
E and E′ are each independently O, S, or NR^{A}, where R^{A} is independently hydrogen, C₁-C₄₀ hydrocarbyl, substituted C₁-C₄₀ hydrocarbyl, or a heteroatom-containing group, such as both E and E′ are O;
each L is independently a Lewis base;
X′ is an anionic ligand;
any two or more L groups may be joined together to form a polydentate (e.g., bidentate) Lewis base;
an X′ group may be joined to an L group to form a monoanionic bidentate group;
n is 1;
m is 0, 1, or 2;
n+m is not greater than 3;
each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
each of R⁵, R⁶, R⁷, R⁸, R^{5′}, R^{6′}, R^{7′}; R^{8′}, R¹⁰, R¹¹, and R¹² is independently hydrogen, C₁-C₄₀ hydrocarbyl, substituted C₁-C₄₀ hydrocarbyl, a heteroatom or a heteroatom-containing group, or one or more of R⁵ and R⁶, R⁶ and R⁷, R⁷ and R⁸, R^{5′} and R^{6′}, R^{6′} and R⁷, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In Formula (II), E and E′ are each independently selected from oxygen or NR^{A} where R^{A} is independently hydrogen, C₁-C₄₀ hydrocarbyl, substituted C₁-C₄₀ hydrocarbyl, or a heteroatom-containing group. In some embodiments, E and E′ are oxygen. When E and/or E′ are NR^{A}, R^{A} can be selected from C₁ to C₂₀ hydrocarbyls, alkyls, or aryls. In one embodiment, E and E′ are each independently selected from O, S, N(alkyl), or N(aryl), where the alkyl can be a C₁ to C₂₀ alkyl, such as methyl, ethyl, propyl, butyl, pentyl, hexyl, octyl, nonyl, decyl, undecyl, dodecyl, and the like, and aryl is a C₆ to C₄₀ aryl group, such as phenyl, naphthalenyl, benzyl, methylphenyl, and the like.

In some embodiments of catalyst compounds of Formula (I) or (II), when E and E′ are oxygen, each phenolate group can be substituted in the position that is next to the oxygen atom (i.e. R¹ and R^{1′} in Formula (I) and (II)). Thus, when E and E′ are oxygen, each of R¹ and R^{1′} is independently a C₁-C₄₀ hydrocarbyl, a substituted C₁-C₄₀ hydrocarbyl, a heteroatom, or a heteroatom-containing group, such as each of R¹ and R^{1′} is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (I) or (II), each of R¹ and R^{1′} is independently a tertiary hydrocarbyl group. In other embodiments of Formula (I) or (II), each of R¹ and R^{1′} is independently a (substituted or unsubstituted) cyclic tertiary hydrocarbyl group. In other embodiments of the catalyst compound of Formula (I) or (II), each of R¹ and R^{1′} is independently a (substituted or unsubstituted) polycyclic tertiary hydrocarbyl group.

In some embodiments of catalyst compounds of Formula (I) or (II), when E and E′ are oxygen, each phenolate group can be substituted in the position that is para to the oxygen atom (i.e. R³ and R^{3′} in Formula (I) and (II)). Thus, when E and E′ are oxygen, each of R³ and R^{3′} is independently a C₁-C₄₀ hydrocarbyl, a substituted C₁-C₄₀ hydrocarbyl, a heteroatom, or a heteroatom-containing group, such as each of R³ and R^{3′} is independently C₁-C₂₀ alkyl, such as methyl, ethyl, propyl, butyl, pentyl, hexyl, heptyl, octyl, nonyl, decyl, or an isomer thereof. Alternatively, each of R³ and R^{3′} is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (I) or (II), each of R³ and R^{3′} is independently a (substituted or unsubstituted) C₁-C₂₀ alkyl, such as methyl, ethyl, propyl, butyl, pentyl, hexyl, heptyl, octyl, nonyl, decyl, or isomers thereof. In some embodiments of the catalyst compound of Formula (I) or (II), each of R³ and R^{3′} is independently a (substituted or unsubstituted) acyclic tertiary hydrocarbyl group. In other embodiments of Formula (I) or (II), each of R³ and R^{3′} is independently a tert-butyl.

In some embodiments, one or more of R¹, R², R³, R⁴, R^{1′}, R^{2′}, R^{3′}, R^{4′}, R⁵, R⁶, R⁷, R⁸, R^{5′}, R^{6′}, R^{7′}; R^{8′}, R¹⁰, R¹¹, or R¹² of Formula (II) are independently hydrogen or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments of Formula (I) or (II), M is a group 3 metal, such as Sc, Y, or La.

In some embodiments of Formula (I) and (II), each of E and E′ is O.

In some embodiments of Formula (I) and (II), each of R¹, R², R³, R⁴, R^{1′}, R^{2′}, R^{3′} and R^{4′} is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In embodiments of Formula (I) and (II), each X′ is, independently, selected from hydrocarbyl radicals having from 1 to 20 carbon atoms (such as alkyls or aryls), hydrides, amides, alkoxides, sulfides, phosphides, halides, alkyl sulfonates, and a combination thereof, such as each X′ is independently selected from halides, aryls, and C₁ to C₅ alkyl groups, such as each X′ is independently a hydrido, dimethylamido, diethylamido, bis(dimethylsilyl)amido, bis(trimethylsilyl) amido, methylenetrimethylsilyl, neopentyl, phenyl, benzyl, methyl, ethyl, propyl, butyl, pentyl, fluoro, iodo, bromo, or chloro group. In some embodiments, each X′ is independently selected from bis(dimethylsilyl)amido, bis(trimethylsilyl) amido, and methylenetrimethylsilyl.

Alternatively, each X′ may be, independently, a halide, a hydride, an alkyl group, or an alkenyl group.

In some embodiments of Formula (I) and (II), each L is a Lewis base, independently, selected from ethers, thio-ethers, amines, nitriles, imines, pyridines, halocarbons, and phosphines, such as ethers, thioethers, or a combination thereof, optionally two or more L's may form a part of a fused ring or a ring system, such as each L is independently selected from ether or thioether groups, such as each L is an ethyl ether, tetrahydrofuran, dibutyl ether, or dimethylsulfide group.

In some embodiments of Formula (I) and (II), each of R¹ and R^{1′} is independently cyclic tertiary alkyl groups.

In some embodiments of Formula (I) and (II), m is 0, 1 or 2, such as 0.

In some embodiments of Formula (I) and (II), each of R¹ and R^{1′} is not hydrogen.

In some embodiments of Formula (I) and (II), each of R³ and R^{3′} is not hydrogen.

In some embodiments of Formula (I) and (II), M is Sc, Y, or La, each of E and E′ is O; each of R¹ and R^{1′} is independently a C₁-C₄O hydrocarbyl, a substituted C₁-C₄₀ hydrocarbyl, a heteroatom or a heteroatom-containing group, each of R², R³, R⁴, R^{2′}, R^{3′}, and R^{4′} is independently hydrogen, C₁-C₂₀ hydrocarbyl, or substituted C₁-C₂₀ hydrocarbyl.

In some embodiments of Formula (II), each of R⁵, R⁶, R⁷, R⁸, R^{5′}, R^{6′}, R⁷, R^{8′}, R¹⁰, R¹¹ and R¹² is independently hydrogen, methyl, ethyl, propyl, butyl, pentyl, hexyl, or an isomer thereof.

In some embodiments of Formula (II), each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, or isomers thereof.

In some embodiments of Formula (II), M is Sc, Y, or La, each of E and E′ is O; each of R¹ and R^{1′} is independently a C₁-C₄₀ hydrocarbyl, a substituted C₁-C₄₀ hydrocarbyl, a heteroatom or a heteroatom-containing group; each of R³ and R^{3′} is independently a C₁-C₄₀ hydrocarbyl, a substituted C₁-C₄₀ hydrocarbyl, a heteroatom or a heteroatom-containing group; each of R¹, R², R⁴, R^{1′}, R^{2′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
each X′ is, independently, selected from the group consisting of substituted or unsubstituted: hydrocarbyl radicals having from 1 to 20 carbon atoms (such as alkyls or aryls), hydrides, amides, alkoxides, sulfides, phosphides, halides, dienes, amines, phosphines, ethers, and a combination thereof, (two or more X's may form a part of a fused ring or a ring system); n is 2; m is 0; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, substituted C₁-C₂₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formula (II), M is Sc, Y, or La, both E and E′ are oxygen, both R¹ and R^{1′} are independently C₄-C₂₀ cyclic tertiary alkyl, and both R³ and R^{3′} are independently C₁-C₁₀ alkyl.

In some embodiments of Formula (II), M is Sc, Y, or La, both E and E′ are oxygen, both R¹ and R^{1′} are adamantan-1-yl or substituted adamantan-1-yl, and both R³ and R^{3′} are independently C₁-C₁₀ alkyl.

In some embodiments of Formula (II), M is Sc, Y, or La, both E and E′ are oxygen, and each of R¹, R^{1′}, R³ and R^{3′} are independently adamantan-1-yl or substituted adamantan-1-yl.

In some embodiments, the catalyst compound is represented by Formula (III):

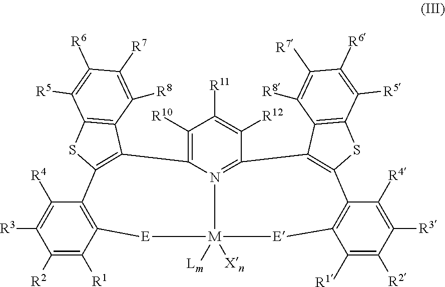

wherein:
M is a group 3 metal or a lanthanide metal (such as M is Sc, Y, or La);
E and E′ are each independently O, S, or NR^{A}, where R^{A} is independently hydrogen, C₁-C₄₀ hydrocarbyl, substituted C₁-C₄₀ hydrocarbyl, or a heteroatom-containing group, such as O, such as both E and E′ are O;
each L is independently a Lewis base;
each X′ is independently an anionic ligand;
any two L groups may be joined together to form a bidentate Lewis base;
an X′ group may be joined to an L group to form a monoanionic bidentate group;
n is 1;
m is 0, 1, or 2;
n+m is not greater than 3;
each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R^{1′} and R^{2′}, R^{2′} and R^{3′}, or R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings; and
each of R⁵, R⁶, R⁷, R⁸, R^{1′}, R^{6′}, R^{7′}; R^{8′}, R¹⁰, R¹¹, and R¹² is independently hydrogen, C₁-C₄₀ hydrocarbyl, substituted C₁-C₄₀ hydrocarbyl, a heteroatom or a heteroatom-containing group, or one or more of R⁵ and R⁶, R⁶ and R⁷, R⁷ and R⁸, R^{5′} and R^{6′}, R^{6′} and R⁷, R^{7′} and R^{8′}, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

In Formula (III), E and E′ are each selected from oxygen or NR^{A}, where R^{A} is independently hydrogen, C₁-C₄₀ hydrocarbyl, substituted C₁-C₄₀ hydrocarbyl, or a heteroatom-containing group. In some embodiments, E and E′ are oxygen. When E and/or E′ are NR^{A}, R^{A} can be selected from C₁ to C₂₀ hydrocarbyls, alkyls, or aryls. In one embodiment, E and E′ are each selected from O, S, N(alkyl), or N(aryl), where the alkyl can be a C₁ to C₂₀ alkyl, such as methyl, ethyl, propyl, butyl, pentyl, hexyl, octyl, nonyl, decyl, undecyl, dodecyl, and the like, and aryl is a C₆ to C₄₀ aryl group, such as phenyl, naphthalenyl, benzyl, methylphenyl, and the like.

In some embodiments of catalyst compounds of Formula (III), when E and E′ are oxygen, each phenolate group can be substituted in the position that is next to the oxygen atom (i.e. R¹ and R^{1′} in Formula (III)). Thus, when E and E′ are oxygen, each of R¹ and R^{1′} is independently a C₁-C₄₀ hydrocarbyl, a substituted C₁-C₄₀ hydrocarbyl, a heteroatom, or a heteroatom-containing group, R¹ and R^{1′} is independently C₁-C₂₀ alkyl, such as methyl, ethyl, propyl, butyl, pentyl, hexyl, heptyl, octyl, nonyl, or decyl. Alternatively, each of R¹ and R^{1′} is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (III), each of R¹ and R^{1′} is independently a (substituted or unsubstituted) acyclic tertiary hydrocarbyl group. In other embodiments of Formula (III), each of R¹ and R^{1′} is independently a tert-butyl.

In some embodiments, each of R¹ and R^{1′} is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (III), each of R¹ and R^{1′} is independently a tertiary hydrocarbyl group. In other embodiments of Formula (III), each of R¹ and R^{1′} is independently a cyclic tertiary hydrocarbyl group. In other embodiments of the catalyst compound of Formula (III), each of R¹ and R^{1′} is independently a polycyclic tertiary hydrocarbyl group.

In some embodiments of catalyst compounds of Formula (III), when E and E′ are oxygen, each phenolate group can be substituted in the position that is para to the oxygen atom (i.e., R³ and R^{3′} in Formula (III)). Thus, when E and E′ are oxygen, each of R³ and R^{3′} is independently a C₁-C₄₀ hydrocarbyl, a substituted C₁-C₄₀ hydrocarbyl, a heteroatom, or a heteroatom-containing group, such as each of R³ and R^{3′} is independently C₁-C₂₀ alkyl, such as methyl, ethyl, propyl, butyl, pentyl, hexyl, heptyl, octyl, nonyl, decyl, or an isomer thereof. Alternatively, each of R³ and R^{3′} is independently a non-aromatic cyclic alkyl group with one or more five- or six-membered rings (such as cyclohexyl, cyclooctyl, adamantyl, or 1-methylcyclohexyl, or substituted adamantyl), such as a non-aromatic cyclic tertiary alkyl group (such as 1-methylcyclohexyl, adamantyl, or substituted adamantyl).

In some embodiments of the catalyst compound of Formula (III), each of R³ and R^{3′} is independently a (substituted or unsubstituted) C₁-C₂₀ alkyl, such as methyl, ethyl, propyl, butyl, pentyl, hexyl, heptyl, octyl, nonyl, decyl, or isomers thereof. In some embodiments of the catalyst compound of Formula (III), each of R³ and R^{3′} is independently a (substituted or unsubstituted) acyclic tertiary hydrocarbyl group. In some embodiments of Formula (III), each of R³ and R^{3′} is independently a tert-butyl.

In some embodiments, one or more of R¹, R², R³, R⁴, R^{1′}, R^{2′}, R^{3′}, R^{4′}, R⁵, R⁶, R⁷, R⁸, R^{5′}, R^{6′}, R^{7′}; R^{8′}, R¹⁰, R¹¹, or R¹² of Formula (III) are independently hydrogen or C₁ to C₂₀ alkyl, such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, or an isomer thereof, such as isopropyl, etc.

In some embodiments of Formula (III), M is a group 3 metal, such as Sc, Y, or La.

In some embodiments of Formula (III), each of E and E′ is O.

In some embodiments of Formula (III), each of R¹, R², R³, R⁴, R^{1′}, R^{2′}, R^{3′}, and R^{4′} is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, and isomers thereof.

In embodiments of Formula (III), R^{A} is hydrogen, C₁-C₄₀ hydrocarbyl, substituted C₁-C₄₀ hydrocarbyl, or a heteroatom-containing group, such as R^{A} is hydrogen, methyl, ethyl, propyl, butyl, pentyl, hexyl, or an isomer thereof.

In embodiments of Formula (III), each X′ is, independently, selected from hydrocarbyl radicals having from 1 to 20 carbon atoms (such as alkyls or aryls), hydrides, amides, alkoxides, sulfides, phosphides, halides, alkyl sulfonates, and a combination thereof, (two or more X's may form a part of a fused ring or a ring system), such as each X′ is independently selected from halides, aryls, and C₁ to C₅ alkyl groups, such as each X′ is independently a hydrido, dimethylamido, diethylamido, bis(dimethylsilyl)amido, bis(trimethylsilyl) amido, methylenetrimethylsilyl, neopentyl, phenyl, benzyl, methyl, ethyl, propyl, butyl, pentyl, fluoro, iodo, bromo, or chloro group. In some embodiments, each X′ is independently selected from bis(dimethylsilyl)amido, bis(trimethylsilyl) amido, and methylenetrimethylsilyl.

Alternatively, each X′ may be, independently, a halide, a hydride, an alkyl group, or an alkenyl group.

In some embodiments of Formula (III), each L is a Lewis base, independently, selected from ethers, thio-ethers, amines, nitriles, imines, pyridines, halocarbons, and phosphines, such as ethers, thioethers, or a combination thereof, optionally two or more L's may form a part of a fused ring or a ring system, such as each L is independently selected from ether or thioether groups, such as each L is an ethyl ether, tetrahydrofuran, dibutyl ether, or dimethylsulfide group.

In some embodiments of Formula (III), each of R¹ and R^{1′} is independently tertiary alkyl groups.

In some embodiments of Formula (III), m is 0, 1, or 2, such as 0.

In some embodiments of Formula (III), each of R¹ and R^{1′} is not hydrogen.

In some embodiments of Formula (III), each of R³ and R^{3′} is not hydrogen.

In some embodiments of Formula (III), M is Sc, Y, or La, each of E and E′ is O; each of R¹ and R^{1′} is independently a C₁-C₄₀ hydrocarbyl, a substituted C₁-C₄₀ hydrocarbyl, a heteroatom or a heteroatom-containing group, each of R², R³, R⁴, R^{2′}, R^{3′}, and R^{4′} is independently hydrogen, C₁-C₂₀ hydrocarbyl, or substituted C₁-C₂₀ hydrocarbyl.

In some embodiments of Formula (III), each of R⁵, R⁶, R⁷, R⁸, R^{5′}, R^{6′}, R^{7′}, R^{8′}, R¹⁰, R¹¹ and R¹² is independently hydrogen, methyl, ethyl, propyl, butyl, pentyl, hexyl, or an isomer thereof.

In some embodiments of Formula (III), each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthalenyl, cyclohexyl, cyclohexenyl, methylcyclohexyl, or isomers thereof.

In some embodiments of Formula (III), M is Sc, Y, or La, each of E and E′ is O; each of R¹ and R^{1′} is independently a C₁-C₄₀ hydrocarbyl, a substituted C₁-C₄₀ hydrocarbyl, a heteroatom or a heteroatom-containing group; each of R³ and R^{3′} is independently a C₁-C₄₀ hydrocarbyl, a substituted C₁-C₄₀ hydrocarbyl, a heteroatom or a heteroatom-containing group;
each of R¹, R², R⁴, R^{1′}, R^{2′}, and R^{4′} is independently hydrogen, C₁-C₂₀ hydrocarbyl, substituted C₁-C₂₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings;
each X′ is, independently, selected from the group consisting of substituted or unsubstituted: hydrocarbyl radicals having from 1 to 20 carbon atoms (such as alkyls or aryls), hydrides, amides, alkoxides, sulfides, phosphides, halides, dienes, amines, phosphines, ethers, and a combination thereof, (two or more X's may form a part of a fused ring or a ring system);
n is 2; m is 0; and each of R⁵, R⁶, R⁷, R⁸, R^{5′}, R^{6′}, R^{7′}, R^{8′}, R¹⁰, R¹¹ and R¹² is independently hydrogen, C₁-C₂₀ hydrocarbyl, substituted C₁-C₂₀ hydrocarbyl, a heteroatom or a heteroatom-containing group, or one or more adjacent R groups may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings, such as each of R⁵, R⁶, R⁷, R⁸, R^{5′}, R^{6′}, R^{7′}, R^{8′}, R¹⁰, R¹¹ and R¹² is independently selected from hydrogen, methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, phenyl, substituted phenyl (such as methylphenyl and dimethylphenyl), benzyl, substituted benzyl (such as methylbenzyl), naphthyl, cyclohexyl, cyclohexenyl, methylcyclohexyl, and isomers thereof.

In some embodiments of Formula (III), M is Sc, Y, or La, both E and E′ are oxygen, both R¹ and R^{1′} are independently C₄-C₂₀ tertiary alkyl (such as tert-butyl), and both R³ and R^{3′} are independently C₁-C₁₀ alkyl.

In some embodiments of Formula (III), M is Sc, Y, or La, both E and E′ are oxygen, both R¹ and R^{1′} are tert-butyl or substituted tert-butyl, and both R³ and R^{3′} are independently C₁-C₁₀ alkyl.

In some embodiments of Formula (III), M is Sc, Y, or La, both E and E′ are oxygen, and each of R¹, R^{1′}, R³ and R^{3′} are independently methyl, substituted methyl, tert-butyl, substituted tert-butyl, adamantan-1-yl, or substituted adamantan-1-yl.

MAO Solutions Useful as Starting Reagents for Making Anion Modified Alkylaluminoxane and/or Cation Modified Alkylaluminoxane.

Aluminoxanes are oligomeric compounds containing —Al(R)—O— or —Al(R)₂—O— subunits, where R is an alkyl group, typically a C₁ to C₁₂ alkyl group, such as the inactive MAO gel shown in Scheme 1. Examples of useful aluminoxanes include methylaluminoxane (MAO), modified methylaluminoxane (MMAO), ethylaluminoxane, triethylaluminoxane, triisobutylaluminoxane, tetraethyldialuminoxane, and di-isobutylaluminoxane.

One of the fresh active MAO solutions from the reaction of largely excess TMA with water at a low enough temperature has a formula (Al₄O₃Me₆)₄(TMA)₁₋₂ with the coordinated TMA number depending on the surrounding TMA concentration (Sinn, et al., “Formation, Structure, and Mechanism of Oligomeric Methylaluminoxane”, in Kaminsky (ed.), Metalorg. Cat. for Synth. & Polym., Springer-Verlag, 1999, p. 105). The fresh active MAO therefore has an Al:O ratio 1:0.75 and the oxygen may increase after aging or removal of free TMA that is in equilibrium with the coordinated TMA (Scheme 1), e.g., about 1:0.78 in a Grace 30% MAO solution after the removal of largely excess TMA to form a product containing about 85 mol % MAO and about 15 mol % total TMA (Imhoff, et al., Organometallics, 1998, 17 (10), p. 1941). The gelation process starts after the solution MAO is made even under cooling. The solution MAO composition can therefore change with time, e.g., by the observation of increasing oxygen content in the main MAO structures with the increase of free TMA and decrease of coordinated TMA. Preferably solution MAO with a similar age under similar storage conditions should be used; more preferably solution MAO with an age younger than 6 months under a low temperature storage, e.g., lower than −10° C., more preferably lower than −20° C., most preferably lower than −30° C., should be used; and most preferably, the solution MAO with an age less than a week under cooling, e.g., lower than −10° C., such as lower than −20° C., such as lower than −30° C., should be used.

There are a variety of methods for preparing MAO and modified MAO, such as the methods described in U.S. Pat. No. 4,542,199 and Chen and Marks, 100 Chem. Rev. 1391 (2000). MAO can also be modified for different purposes, e.g., increasing activity or solubility. Examples of useful MAO include MAO from TMA with an oxygenate (e.g., W. R. Grace MAO from TMA with water, or Nouryon PMAO from TMA with an organic oxygen source, or Tosoh solid MAO), higher alkyl modified MAO (e.g., Nouryon MMAO), carbocation agent modified MAO (U.S. Pat. No. 9,090,720), dialkylaluminum cation precursor agent modified MAO (U.S. Pat. No. 8,575,284), halogen modified MAO (U.S. Pat. No. 7,355,058), etc.

Active MAO can also be formed from the contact of largely excess TMA with a non-hydrolytic oxygen source (such as CO₂, methylacylic acid, benzoic acid, or other reactive oxygen containing organics) under suitable reaction conditions.

Active MAO of the present disclosure can be obtained commercially or synthesized. Active MAO of the present disclosure can be prepared in situ by contacting a hydrocarbyl aluminum compound with an oxygen source, e.g., TMA with water in an aliphatic or aromatic diluent, at a temperature of less than 0° C. to about −60° C., such as about −10° C. to about −50° C., such as about −15° C. to about −30° C.

Hydrocarbyl Aluminum Compounds for MAO and Modified MAO. The active aluminoxane composition (such as MAO) can be exclusively formed with trimethylaluminum (TMA), but other aluminumalkyl compounds can be used to modify the MAO. The hydrocarbyl aluminum compounds used for aluminoxane modification can be alkylaluminum compounds such as a trialkylaluminum compound. For example, the alkyl substituents can be alkyl groups of up to 10 carbon atoms, such as octyl, isobutyl, ethyl or methyl. Thus, suitable hydrocarbyl aluminum compounds may include trimethylaluminum, triethylaluminum, tripropylalumiuum, tri-n-butylaluminum, tri-isobutyl-aluminum, tri(2-methylpentyl)aluminum, trihexylaluminum, tri-n-octylaluminum, and tri-n-decylaluminum. In some embodiments, hydrocarbyl aluminum compounds are trimethylaluminum and tri-n-octylaluminum. In some embodiments, hydrocarbyl aluminum compounds are represented by the formula R₃Al where each R is independently a hydrocarbon containing between 1 and 30 carbon atoms.

In some embodiments, the hydrocarbyl aluminum compound is one or more of trialkylaluminum mixtures, e.g., dimethylethylaluminum or methyldiethylaluminum from AlMe₃ and AlEt₃ mixture, diethylisobutylaluminum or ethyldiisobutylaluminum from AlEt₃ and AliBu₃ mixture, and the like.

Oxygen Sources. Suitable oxygen sources for forming alkylaluminoxanes of the present disclosure include any oxygen sources in which one or more oxygen atoms is able to react with the hydrocarbyl aluminum compound to form a new Al—O bond. In at least one embodiment, the oxygen source may be or include water, such as pure water or water in a metal salt hydrate. In some embodiments, the oxygen source can be one or more hydroxyl or carbonyl containing compounds for example an alcohol, CO or CO₂, an acetone, or a carboxylic acid. In at least one embodiment of the present disclosure, the oxygen source is one or more of carbon dioxide, a carboxylic acid, a ketone, an aldehyde, an ester, an anhydride, an alcohol, or combination thereof.

In at least one embodiment of the present disclosure, the oxygen source is represented by the formula R¹R²C═CR³CO₂H wherein each of R¹ and R² is independently hydrogen, alkyl, alkenyl, aryl or heteroatom containing group and R³ is alkyl, alkenyl, aryl or heteroatom containing group.

In at least one embodiment of the present disclosure, the oxygen source includes in the hydrocarbyl aluminum compound, e.g., the reaction product of TMA with an alcohol, a ketone, an ester, or an organic acid. Examples of hydrocarbyl aluminum compounds which include an oxygen source include dimethyl aluminum methoxide, dimethyl aluminum ethoxide, dimethyl aluminum isopropoxide, dimethyl aluminum n-butoxide, dimethyl aluminum isobutoxide, pentamethyldialuminum-t-butoxide, tetramethyldialuminumdi-t-butoxide, pentamethyldialuminum-i-propoxide, tetramethyldialuminum di-i-propoxide, or combinations thereof.

The starting charging molar ratio of Al:O, where O is the active oxygen in the active oxygen containing compound, can be about 100:1, about 60:1, about 30:1, about 10:1, about 1:1, or about 0.9:1 to form the desired MAO compositions with or without excess free hydrocarbyl aluminum compounds. In some embodiments, the molar ratio of Al:O can be about 0.9:1 to about 100:1, such as about 1:1 to about 10:1, alternatively about 10:1 to about 60:1, such as about 30:1 to about 60:1. If undesired excess hydrocarbyl aluminum compound(s) is (are) present, it (they) can be removed, for example, by filtration and then washed with an aliphatic diluent and/or treated with fluorine compound(s) of the present disclosure.

In some embodiments, the oxygen source is one or more of carbon dioxide, a carboxylic acid, an ester, an anhydride, an alcohol or combination thereof. In some embodiments, the oxygen source is one or more of carbon dioxide, a carboxylic acid, an ester, an anhydride and an alcohol or combination thereof, optionally containing water. In some embodiments, the oxygen source is R¹R²C═CR³CO₂H wherein each of R¹ and R² is independently hydrogen, alkyl, alkenyl, aryl or heteroatom containing group and R³ is alkyl, alkenyl, aryl or heteroatom containing group. In some embodiments, the oxygen source is methacrylic acid.

In at least one embodiment of the present disclosure, the oxygen source is a hydrocarbylboroxine as described in Welborn, U.S. Pat. No. 5,001,244.

### Catalyst System Formation

Catalyst systems of the present disclosure may include one or more pre-catalyst(s), as described above, and an activator (alkylaluminoxane-free alkylaluminoxane) and may be formed by combining the catalyst compounds of the present disclosure with activators in any manner known from the literature including combining them with supports, such as silica. The catalyst systems may also be added to or generated in solution polymerization or bulk polymerization (in the monomer). Catalyst systems of the present disclosure may have one or more activators and one, two or more pre-catalyst. Activators are defined to be any compound which can activate any one of the pre-catalyst compounds described above by converting the neutral metal compound to a catalytically active metal compound cation. The terms “cocatalyst” and “activator” are used herein interchangeably.

In at least one embodiment, the catalyst system includes an activator, and a pre-catalyst compound of Formula (I), Formula (II), Formula (III), or combinations thereof.

Embodiments of the present disclosure include methods for preparing a catalyst system including contacting, in an organic diluent, the unsupported anion modified, or cation modified MAO (TMA free solution) or supported anion modified or cation modified MAO (TMA free support) with at least one pre-catalyst compound having a Group 3 atom or lanthanide metal atom. Alternatively, an anion modified, or cation modified MAO is first brought into contact with at least one pre-catalyst compound before contacting the support.

In at least one embodiment, the unsupported anion modified, or cation modified MAO or supported anion modified or cation modified MAO is heated prior to contact with the catalyst compound.

The unsupported anion modified, or cation modified MAO or supported anion modified or cation modified MAO can be solvated or slurried in an organic diluent and the resulting mixture is contacted with a solution of at least one catalyst compound. The catalyst compound can also be added as a solid to the mixture of the organic diluent and the anion modified or cation modified MAO. In at least one embodiment, the mixture of the anion modified, or cation modified MAO is contacted with the catalyst compound for a period of time of about 0.02 hours to about 24 hours, such as about 0.1 hours to about 1 hour, about 0.2 hours to about 0.6 hours, about 2 hours to about 16 hours, or about 4 hours to about 8 hours.

The mixture of the catalyst compound and the anion modified, or cation modified MAO may be heated to a temperature of about 0° C. to about 70° C., such as about 23° C. to about 60° C., for example room temperature. Contact times may be about 0.02 hours to about 24 hours, such as about 0.1 hours to about 1 hour, about 0.2 hours to about 0.6 hours, about 2 hours to about 16 hours, or about 4 hours to about 8 hours.

Suitable organic diluents are materials in which some or all of the reactants used herein, e.g., the anion modified, or cation modified MAO and the catalyst compound, are at least partially soluble (or in the case of the solid support, suspended) and which are liquid at reaction temperatures. Non-limiting example diluents are non-cyclic alkanes with formula CₙH₍₂ₙ₊₂₎ where n is 4 to 30, such as isobutane, butane, isopentane, hexane, n-heptane, octane, nonane, decane and the like, and cycloalkanes with formula CₙH₍₂ₙ₋₂₎ where n is 5 to 30, such as cyclopentane, methylcyclopentane, cyclohexane, methylcyclohexane and mixtures thereof. Aromatic diluent can include benzene, toluene, or xylenes.

The diluent can be charged into a reactor, followed by an anion modified or cation modified MAO. Catalyst can then be charged into the reactor, such as a solution of catalyst in an organic diluent or as a solid. The mixture can be stirred at a temperature, such as room temperature. Additional diluent may be added to the mixture to form a mixture having a desired consistency, such as a slurry having from about 2 cc/g of silica to about 20 cc/g silica, such as about 4 cc/g. The diluent can then be removed. Removing diluent dries the mixture and may be performed under a vacuum atmosphere, purged with inert atmosphere, heating of the mixture, or combinations thereof. For heating of the mixture, any suitable temperature can be used that evaporates the aliphatic diluent. It is to be understood that reduced pressure under vacuum will lower the boiling point of the aliphatic diluent depending on the pressure of the reactor. Diluent removal temperatures can be about 10° C. to about 200° C., such as about 60° C. to about 140° C., such as about 60° C. to about 120° C., for example about 80° C. or less, such as about 70° C. or less. In at least one embodiment, removing diluent includes applying heat, applying vacuum, and applying nitrogen purged from bottom of the vessel by bubbling nitrogen through the mixture. The mixture is dried.

### Polymerization Processes

The present disclosure relates to polymerization processes where monomer (e.g., ethylene; propylene), and optionally comonomer, are contacted with a catalyst system including an activator and at least one pre-catalyst compound, as described above. The pre-catalyst compound and activator may be combined in any suitable order. The pre-catalyst compound and activator may be combined prior to contacting with the monomer. Alternatively, the pre-catalyst compound and activator may be introduced into the polymerization reactor separately, wherein they subsequently react to form the active catalyst.

Monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In another embodiment, the monomer includes propylene and an optional comonomer including one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and or one or more functional groups.

Exemplary C₂ to C₄₀ olefin monomers and optional comonomers may include ethylene, propylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

Polymerizations of the present disclosure can include copolymerization of butadiene and ethylene. In general, the copolymerization of ethylene with butadiene on an industrial scale is considered a difficult process, as the reaction mechanism of polymerization and relative reactivities of the monomers is believed to differ. The polymerization processes described herein have been found to reduce the manufacture and processing issues associated with such polymers—the processes being shown to produce high molecular weight polymer with increased catalyst activity.

In some embodiments, polymerization processes are conducted through contacting the monomer composition, that includes ethylene and one or more conjugated dienes, with a catalyst system having one or more catalyst compounds and an activator, as described above. The catalyst compound and activator may be combined in any order and are combined typically prior to contacting with the monomer.

Example conjugated diene monomers can include any hydrocarbon structure, such as C₄ to C₃₀, having at least two unsaturated bonds that are adjacent to each other. Examples of conjugated dienes include isoprene, 1,3-butadiene, 1,3-pentadiene, 1,3-hexadiene, 1,3-heptadiene, 1,3-octadiene, 1,3-nonadiene, 1,3-decadiene, cyclopentadiene, dicyclopentadiene or higher ring containing diolefins with or without substituents at various ring positions.

Polymerization processes can be carried out in any suitable manner known in the art. Any suspension, homogeneous, bulk, solution, slurry, or gas phase polymerization process can be used. Such processes can be run in a batch, semi-batch, or continuous mode. Homogeneous polymerization processes and slurry processes can be employed. (A homogeneous polymerization process is defined to be a process where at least 90 wt % of the product is soluble in the reaction media.) A homogeneous process can be a bulk homogeneous process. (A bulk process is defined to be a process where monomer concentration in all feeds to the reactor is 70 vol % or more.) Alternately, no solvent or diluent is present or added in the reaction medium, (except for the small amounts used as the carrier for the catalyst system or other additives or amounts typically found with the monomer). In another embodiment, the process is a slurry process. As used herein, the term “slurry polymerization process” means a polymerization process where a supported catalyst is employed, and monomers are polymerized on the supported catalyst particles. At least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In a preferred embodiment of the invention, aliphatic hydrocarbon solvents are used as the solvent, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, preferably less than 0.5 wt %, preferably less than 0 wt % based upon the weight of the solvents.

In at least one embodiment, a feedstream to the reactor has a feed concentration of the monomers and comonomers for the polymerization is 60 vol % diluent or less, such as 40 vol % or less, such as 20 vol % or less, based on the total volume of the feedstream. In at least one embodiment, the polymerization is run in a bulk process.

Polymerizations can be run at any temperature and or pressure suitable to obtain the desired polymers. Suitable temperatures and or pressures include a temperature of about 0° C. to about 300° C., such as about 20° C. to about 200° C., such as about 35° C. to about 160° C., such as about 80° C. to about 160° C., such as about 85° C. to about 140° C. Polymerizations can be run at a pressure of about 0.1 MPa to about 25 MPa, such as about 0.45 MPa to about 6 MPa, or about 0.5 MPa to about 4 MPa.

In a suitable polymerization, the run time of the reaction can be up to about 1,500 minutes, such as about 1,200 minutes, such as about 300 minutes, such as about 5 minutes to about 250 minutes, such as about 10 minutes to about 120 minutes, such as about 20 minutes to about 90 minutes, such as about 30 minutes to about 60 minutes. In a continuous process the run time may be the average residence time of the reactor. In at least one embodiment, the run time of the reaction is up to about 180 minutes. In a continuous process the run time may be the average residence time of the reactor.

In at least one embodiment, hydrogen is present in the polymerization reactor at a partial pressure of about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa).

In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

In at least one embodiment, aluminoxane can be present at zero mol %, alternately the aluminoxane can be present at a molar ratio of aluminum to Group 3 rare earth metal or lanthanide less than 500:1, such as less than 300:1, such as less than 100:1, such as less than 1:1.

In at least one embodiment, the polymerization: 1) is conducted at temperatures of about 0° C. to about 300° C. (such as about 25° C. to about 250° C., such as about 50° C. to about 160° C., such as about 80° C. to about 140° C.); 2) is conducted at a pressure of atmospheric pressure to about 10 MPa (such as about 0.35 MPa to about 10 MPa, such as about 0.45 MPa to about 6 MPa, such as about 0.5 MPa to about 4 MPa); 3) is conducted in an aliphatic hydrocarbon diluent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; such as where aromatics are present in the diluent at less than 1 wt %, such as less than 0.5 wt %, such as at 0 wt % based upon the weight of the diluents); 4) wherein the catalyst system used in the polymerization comprises less than 0.5 mol %, such as about 0 mol % aluminoxane, alternately the aluminoxane is present at a molar ratio of aluminum to transition metal less than 500:1, such as less than 300:1, such as less than 100:1, such as less than 1:1; 5) the polymerization occurs in one reaction zone; 6) optionally scavengers (such as trialkyl aluminum compounds) are absent (e.g., present at zero mol %, alternately the scavenger is present at a molar ratio of scavenger metal to transition metal of less than 100:1, such as less than 50:1, such as less than 15:1, such as less than 10:1); and 7) optionally hydrogen is present in the polymerization reactor at a partial pressure of about 0.001 psig to about 50 psig (0.007 kPa to 345 kPa) (such as about 0.01 psig to about 25 psig (0.07 kPa to 172 kPa), such as about 0.1 psig to about 10 psig (0.7 kPa to 70 kPa)). In at least one embodiment, the catalyst system used in the polymerization includes no more than one catalyst compound. A “reaction zone” also referred to as a “polymerization zone” is a vessel where polymerization takes place, for example a stirred-tank reactor or a loop reactor. When multiple reactors are used in a continuous polymerization process, each reactor is considered as a separate polymerization zone. For a multi-stage polymerization in a batch polymerization process, each polymerization stage is considered as a separate polymerization zone. In at least one embodiment, the polymerization occurs in one reaction zone. Room temperature is 23° C. unless otherwise noted.

Other additives may also be used in the polymerization, as desired, such as one or more scavengers, hydrogen, aluminum alkyls, or chain transfer agents such as alkylaluminoxanes, a compound represented by the formula AlR₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylaluminoxane, trimethylaluminum, triisobutylaluminum, trioctylaluminum, or a combination thereof.

In some embodiments, the polymerization process is a solution phase polymerization process. A solution polymerization is a polymerization process in which the polymer is dissolved in a liquid polymerization medium, such as an inert solvent or monomer(s) or their blends. A solution polymerization is typically homogeneous. A homogeneous polymerization is one where the polymer product is dissolved in the polymerization medium. Such systems are not turbid as described in Oliveira, J. V. et al. (2000) Ind. Eng, Chem. Res. v. 29, pg. 4627. Solution polymerization may involve polymerization in a continuous reactor in which the polymer formed, the starting monomer and catalyst materials supplied are agitated to reduce or avoid concentration gradients and in which the monomer acts as a diluent or solvent or in which a hydrocarbon is used as a diluent or solvent. Suitable processes can operate at temperatures from about 0° C. to about 250° C., such as from about 50° C. to about 170° C., such as from about 80° C. to about 150° C., and or at pressures of about 0.1 MPa or more, such as 0.5 MPa or more. The upper pressure limit is not critically constrained but can be about 200 MPa or less, such as 120 MPa or less, such as 30 MPa or less. Temperature control in the reactor can be obtained by balancing the heat of polymerization and with reactor cooling by reactor jackets or cooling coils to cool the contents of the reactor, auto refrigeration, pre-chilled feeds, vaporization of liquid medium (diluent, monomers, or solvent) or combinations of all three. Adiabatic reactors with pre-chilled feeds can also be used. The purity, type, and amount of solvent can be optimized for the maximum catalyst productivity for a particular type of polymerization. The solvent can be also introduced as a catalyst carrier. The solvent can be introduced as a gas phase or as a liquid phase depending on the pressure and temperature. Advantageously, the solvent can be kept in the liquid phase and introduced as a liquid. Solvent can be introduced in the feed to the polymerization reactors.

A process described herein can be a solution polymerization process that may be performed in a batchwise fashion (e.g., batch; semi-batch) or in a continuous process. Suitable reactors may include tank, loop, and tube designs. In at least one embodiment, the process is performed in a continuous fashion and dual loop reactors in a series configuration are used. In at least one embodiment, the process is performed in a continuous fashion and dual continuous stirred-tank reactors (CSTRs) in a series configuration are used. Furthermore, the process can be performed in a continuous fashion and a tube reactor can be used. In another embodiment, the process is performed in a continuous fashion and one loop reactor and one CSTR are used in a series configuration. The process can also be performed in a batchwise fashion and a single stirred tank reactor can be used.

### Catalyst Activity and Polymer Properties

Unless otherwise indicated, catalyst activity is a measure of how active the catalyst is and is reported as the mass of product polymer (P) produced per mole of catalyst (cat) used (kgP/molcat) or as the mass of product polymer (P) produced per mass of catalyst (cat) used (gP/gcat). The amount (mole or mass) of catalyst refers to the amount (mole or mass) of metal element of the catalyst. Catalyst activity may also be expressed over a period of time T of hours and reported as the mass of product polymer (P) produced per mole or millimole of catalyst (cat) used and expressed in units of gPmmolcat⁻¹hr⁻¹. The activity of the catalyst utilized in the copolymerization of ethylene and conjugated dienes is dependent on the structure of the catalyst, the activator used, the metal element incorporated within the catalyst, the concentration of the catalyst within the reaction media, and/or the composition of the monomer system being copolymerized. In some embodiments, the catalyst activator is an anion modified or cation modified alkylaluminoxane. In some embodiments, the co-activator is diisobutylaluminum hydride (DIBAL). In some embodiments, the catalyst activity is about 0.01 kg_{polymer}/mol_{cat} to about 350 kg_{polymer}/mol_{cat}, such as about 5 kg_{polymer}/mol_{cat} to about 340 kg_{polymer}/mol_{cat}, such as about 10 kg_{polymer}/mol_{cat} to about 330 kg_{polymer}/mol_{cat}, such as about 25 kg_{polymer}/mol_{cat} to about 320 kg_{polymer}/mol_{cat}, such as about 50 kg_{polymer}/mol_{cat} to about 310 kg_{polymer}/mol_{cat}, such as about 100 kg_{polymer}/mol_{cat} to about 300 kg_{polymer}/mol_{cat}, such as about 150 kg_{polymer}/mol_{cat} to about 290 kg_{polymer}/mol_{cat}, such as about 200 kg_{polymer}/mol_{cat} to about 275 kg_{polymer}/mol_{cat}, such as about 230 kg_{polymer}/mol_{cat} to about 250 kg_{polymer}/mol_{cat}. In some embodiments, the catalyst activity is about 0.01 kg_{polymer}/mol_{cat} to about 285 kg_{polymer}/mol_{cat}. In some embodiments, the catalyst activity is about 5.5 kg_{polymer}/mol_{cat} to about 45 kg_{polymer}/mol_{cat}. In some embodiments, the catalyst activity is about 100 kg_{polymer}/mol_{cat} to about 250 kg_{polymer}/mol_{cat}, such as about 175 kg_{polymer}/mol_{cat} to about 225 kg_{polymer}/mol_{cat}. In some embodiments, the catalyst activity is about 20 kg_{polymer}/mol_{cat} to about 350 kg_{polymer}/mol_{cat}, such as about 230 kg_{polymer}/mol_{cat} to about 260 kg_{polymer}/mol_{cat}.

In some embodiments, the polyolefin products produced are formed via the copolymerization of ethylene and conjugated diene. In general, the copolymerization of ethylene with conjugated diene on an industrial scale is considered a difficult process, as the polymerization mechanism and relative reactivities of the monomers differ from each other. However, the polymerization processes of the present disclosure have been found to reduce the manufacture and processing issues associated with such polymers—the processes being shown to produce high molecular weight polymer with increased catalyst activity.

In some embodiments, the copolymer formed from the copolymerization between ethylene and butadiene is represented by Scheme 5:

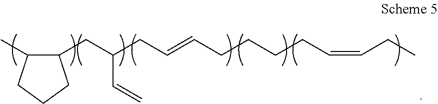

Notable aspects of the copolymer include butadiene units with two adjacent carbon atoms of a cyclopentane ring in the backbone. Some of the butadiene incorporates in the trans-1,4 configuration forming a straight backbone with one unsaturation. Some of the butadiene may also incorporate into the copolymer in the cis-1,4 configuration also forming a straight backbone with one unsaturation but having both of the hydrogens associated with the double bond carbons on the same side of the double bond. Finally, some of the butadiene, usually a very small to nil portion, may incorporate in the 1,2 configuration leaving a pendant vinyl group as an unsaturated branch on the saturated carbon chain. Therefore, the copolymer can be formed with a sufficient amount of residual unsaturation in the backbone or in side chains for eventual use in special applications such as crosslinking or chemical modification.

The ethylene copolymers of the current disclosure have improved properties resulting especially from the more efficient use of diene comonomer in controlling the crystallizability of the polymer. That is, the efficient use of the diene comonomer comprises an improved isolation of the comonomer molecules along the polyethylene chains as not previously achieved for such ethylene copolymers. Accordingly, the polymers of the present disclosure not only have especially good application for those uses previously employing such polymers, but also have excellent overall physical properties in tires including improved traction and low rolling resistance marking a significant improvement over those materials previously available. The improved properties of the polymers result from the isolated dispersion of the diene comonomer and other comonomers along the sequence of the polymer molecule.

In some embodiments, the ethylene copolymers of the present disclosure have a Mw of about 100,000 g/mol to about 2,000,000 g/mol, such as about 110,000 g/mol to about 500,000 g/mol, such as about 113,000 g/mol to about 350,000 g/mol.

In some embodiments, the ethylene copolymers of the present disclosure have a PDI of about 1.5 to about 70, such as about 2 to about 10, such as about 3 to about 6.

In some embodiments, the ethylene copolymers of the present disclosure have about 0.01 mol % to about 10 mol % cyclopentane units along the backbone of the polymer, such as about 0.1 mol % to about 9 mol %, such as about 1 mol % to about 8 mol %, such as about 2.5 mol % to about 7.5 mol %, such as about 4 mol % to about 7 mol %.

In some embodiments, the ethylene copolymers of the present disclosure have about 0.01 mol % to about 3 mol % butadiene in the 1,2 configuration along the backbone of the polymer, such as about 0.1 mol % to about 2 mol %, such as about 0.5 mol % to about 1 mol %.

In some embodiments, the ethylene copolymers of the present disclosure have about 0.01 mol % to about 10 mol % butadiene in the 1,4-trans configuration along the backbone of the polymer, such as about 1 mol % to about 9 mol %, such as about 2.5 mol % to about 8 mol %, such as about 4 mol % to about 7.5 mol %, such as about 5 mol % to about 6 mol %.

In some embodiments, the ethylene copolymers of the present disclosure have about 1 mol % to about 20 mol % butadiene in the 1,4-cis configuration along the backbone of the polymer, such as about 2 mol % to about 19 mol %, such as about 2.5 mol % to about 15 mol %, such as about 3 mol % to about 8 mol %.

In some embodiments, the ethylene copolymers of the present disclosure have an Mw/Mn (PDI) value of about 2 to about 65, such as about 5 to about 55, such as about 10 to about 40, such as about 15 to about 35, alternatively about 20 to about 30.

In some embodiments, a molar ratio of activator to copolymerization pre-catalyst is about 10:1 to about 100:1, such as about 20:1 to about 60:1. It is noted that increasing the activator content relative to the catalyst compound results in increased catalyst activity. Additionally, increasing activator content relative to catalyst leads to lower Mw of the polymer products, thus allowing for accurate control of the Mw in the polymerization process. This is consistent with the coordinative chain transfer mechanism of copolymerization.

In some embodiments, the ethylene copolymers have a thermal melting temperature (Tm) of about 95° C. to about 130° C., such as about 95° C. to about 1115° C., such as about 98° C. to about 110° C. In some embodiments, the ethylene copolymers have two thermal melting temperatures simultaneously.

New bis(phenolate)-catalyst systems based on rare earth elements can be activated by various TMA-free activators to produce copolymers of ethylene with butadiene under mild conditions with high conversions—a process widely considered difficult due to differences in reaction mechanism and monomer reactivity ratios. Interestingly, applicant has discovered that higher activity achieved in reaction mixtures activated by anion modified or cation modified alkylaluminoxanes including F-MAO or ionic MAO compared to the activities obtained by traditional activators (DIMAH-D4/DIBAL or non-TMA free commercial MAOs). Without being bound by theory, the increase in activity is believed to be due to the reduction of free TMA in the activator/catalyst system. As previously noted, free TMA causes poor activity and short catalyst lifetime due to the presence of free TMA in MAO capable of alkylating the pre-catalyst's transition metal center, similar to the alkylation of a metallocene with dichloride leaving groups. The activation of bis(phenolate)-catalysts by activators of the present disclosure can give a polyolefin polymer product containing a substantial amount of 1,2-cyclopentane units in addition to a fairly uniform incorporation of both monomers across the polymer chain. In contrast to that, lanthanide-based metallocene catalysts (e.g., Nd-bisfluorenyl by Michelin) give products containing 1,2-cyclohexane fragments.

Without being bound by theory, the amount of 1,2-cyclopentane units along the polymer backbone affects the morphology of the polymer system produced. For instance, it is well documented that polyethylene is capable of forming crystalline domains due to inter-, and intra-chain interactions. While crystalline domains can provide benefits to polymeric materials, in some cases the amount of crystalline domains within a polymer system can detrimentally affect the physical properties of the resulting materials (e.g. tensile strength, wear resistance, and brittleness). Without being bound by theory, the incorporation of 1,2-cyclopentane units along the polymer backbone disrupt the ability of the of the polymer chains to organize into crystalline domains, thus reducing the percent crystallinity within the system. Additionally, the uniform incorporation of the 1,2-cyclopentane units along the polymer backbone further ensure that polymer crystallization is mitigated due to reduced ethylene-rich regions within the polymer system. Thus, the activation of bis(phenolate) catalysts by TMA-free MAO and ionic MAO affords unique products in high yields that makes these systems very attractive for industrial applications.

### Polymer Functionalization

In some instances, it may be desirable to incorporate polar groups along the backbone of the polymer such that subsequent reactions can take place after the polymerization. In some embodiments, the polymerizations described herein further include utilizing a third monomer that is a metal hydrocarbenyl transfer agent (which is any group 12 or 13 metal agent that contains at least one transferrable group that has an allyl chain end), such as an aluminum vinyl-transfer agent, also referred to as an AVTA, (which is any aluminum agent that contains at least one transferrable group that has an allyl chain end).

Suitable catalyst systems of the present disclosure can have high rates of olefin propagation and negligible or no chain termination via beta hydride elimination, beta methyl elimination, or chain transfer to monomer relative to the rate of chain transfer to the AVTA or other chain transfer agent, such as an aluminum alkyl, if present.

In at least one embodiment of the present disclosure, the aluminum vinyl transfer agent, which is represented by the formula (D):

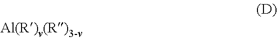

where R′ is a hydrocarbyl group containing 1 to 30 carbon atoms, R″ is a hydrocarbenyl group containing 4 to 20 carbon atoms having an allyl chain end, and v is 0.1 to 3, alternately 1 to 3, alternately 1.1 to less than 3, alternately v is 0.5 to 2.9, 1.1 to 2.9, alternately 1.5 to 2.7, alternately 1.5 to 2.5, alternately 1.8 to 2.2. Suitable compounds represented by the formula Al(R′)₃₋ᵥ(R″)ᵥ are neutral species, but anionic formulations may be envisioned, such as those represented by formula (B): [Al(R′)_{4-w}(R″)_{w}], where w is 0.1 to 4, R′ is a hydrocarbyl group containing 1 to 30 carbon atoms, and R″ is a hydrocarbenyl group containing 4 to 20 carbon atoms having an allyl chain end.

In at least one embodiment of any formula for an aluminum vinyl transfer agent, described herein, each R′ is independently chosen from C₁ to C₃₀ hydrocarbyl groups (such as a C₁ to C₂₀ alkyl groups, such as methyl, ethyl, propyl, butyl, pentyl, hexyl, heptyl, octyl, nonyl, decyl, undecyl, dodecyl, or an isomer thereof), and R″ is represented by the formula:

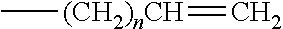

where n is an integer from 2 to 18, such as 6 to 18, such as 6 to 12, such as 6.

Aluminum vinyl transfer agents can include one or more of tri(but-3-en-1-yl)aluminum, tri(pent-4-en-1-yl)aluminum, tri(oct-7-en-1-yl)aluminum, tri(non-8-en-1-yl)aluminum, tri(dec-9-en-1-yl)aluminum, tri(dodec-11-en-1-yl)aluminum, dimethyl(oct-7-en-1-yl)aluminum, diethyl(oct-7-en-1-yl)aluminum, dibutyl(oct-7-en-1-yl)aluminum, diisobutyl(oct-7-en-1-yl)aluminum, diisobutyl(non-8-en-1-yl)aluminum, dimethyl(dec-9-en-1-yl)aluminum, diethyl(dec-9-en-1-yl)aluminum, dibutyl(dec-9-en-1-yl)aluminum, diisobutyl(dec-9-en-1-yl)aluminum, and diisobutyl(dodec-11-en-1-yl)aluminum, methyl-di(oct-7-en-1-yl)aluminum, ethyl-di(oct-7-en-1-yl)aluminum, butyl-di(oct-7-en-1-yl)aluminum, isobutyl-di(oct-7-en-1-yl)aluminum, isobutyl-di(non-8-en-1-yl)aluminum, methyl-di(dec-9-en-1-yl)aluminum, ethyl-di(dec-9-en-1-yl)aluminum, butyl-di(dec-9-en-1-yl)aluminum, isobutyl-di(dec-9-en-1-yl)aluminum, and isobutyl-di(dodec-11-en-1-yl)aluminum.

In at least one embodiment of the present disclosure, particularly useful AVTAs include, but are not limited to, tri(but-3-en-1-yl)aluminum, tri(pent-4-en-1-yl)aluminum, tri(oct-7-en-1-yl)aluminum, tri(non-8-en-1-yl)aluminum, tri(dec-9-en-1-yl)aluminum, dimethyl(oct-7-en-1-yl)aluminum, diethyl(oct-7-en-1-yl)aluminum, dibutyl(oct-7-en-1-yl)aluminum, diisobutyl(oct-7-en-1-yl)aluminum, diisobutyl(non-8-en-1-yl)aluminum, diisobutyl(dec-9-en-1-yl)aluminum, diisobutyl(dodec-11-en-1-yl)aluminum, and the like. Mixtures of one or more AVTAs may also be used. In some embodiments of the present disclosure, isobutyl-di(oct-7-en-1-yl)-aluminum, isobutyl-di(dec-9-en-1-yl)-aluminum, isobutyl-di(non-8-en-1-yl)-aluminum, isobutyl-di(hept-6-en-1-yl)-aluminum are suitable.

Aluminum vinyl transfer agents can include organoaluminum compound reaction products between aluminum reagent (AlR₃) and an alkyl diene. Suitable alkyl dienes include those that have two “alpha olefins”, as described above, at two termini of the carbon chain. The alkyl diene can be a straight chain or branched alkyl chain and substituted or unsubstituted. Exemplary alkyl dienes include but are not limited to, for example, 1,3-butadiene, 1,4-pentadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, 1,14-pentadecadiene, 1,15-hexadecadiene, 1,16-heptadecadiene, 1,17-octadecadiene, 1,18-nonadecadiene, 1,19-eicosadiene, 1,20-heneicosadiene, etc. Exemplary aluminum reagents include triisobutylaluminum, diisobutylaluminumhydride, isobutylaluminumdihydride and aluminum hydride (AlH₃). Useful compounds can be prepared by combining an aluminum reagent (such as alkyl aluminum) having at least one secondary alkyl moiety (such as triisobutylaluminum) and/or at least one hydride, such as a dialkylaluminum hydride, a monoalkylaluminum dihydride or aluminum trihydride (aluminum hydride, AlH₃) with an alkyl diene and heating to a temperature that causes release of an alkylene byproduct. The use of solvent(s) is not required. However, non-polar solvents can be employed, such as, as hexane, pentane, toluene, benzene, xylenes, and the like, or combinations thereof. In at least one embodiment of the present disclosure, the AVTA is free of coordinating polar solvents such as tetrahydrofuran and diethylether. After the reaction is complete, solvent if present, can be removed and the product can be used directly without further purification.

In at least one embodiment, R″ of Formula (D) is butenyl, pentenyl, heptenyl, octenyl or decenyl, such as R″ is octenyl or decenyl. R′ of Formula (D) can be methyl, ethyl, propyl, isobutyl, or butyl, such as R′ is isobutyl.

In at least one embodiment of the present disclosure, v of Formula (D) is about 2, or v is 2.

In at least one embodiment, v of Formula (D) is about 1, or v is 1, such as from about 1 to about 2.

In some embodiments, v of Formula (D) can be an integer or a non-integer, such as v is from 1.1 to 2.9, such as from about 1.5 to about 2.7, e.g., such as from about 1.6 to about 2.4, such as from about 1.7 to about 2.4, such as from about 1.8 to about 2.2, such as from about 1.9 to about 2.1 and all ranges there between.

In at least one embodiment, R′ is isobutyl and each R″ is octenyl or decenyl, and v is from 1.1 to 2.9, such as from about 1.5 to about 2.7, such as from about 1.6 to about 2.4, such as from about 1.7 to about 2.4, such as from about 1.8 to about 2.2, such as from about 1.9 to about 2.1.

The amount of v is described using the formulas: (3-v)+v=3, and Al(R′)ᵥ(R″)₃₋ᵥ where R″ is a hydrocarbenyl group containing 4 to 20 carbon atoms having an allyl chain end, R′ is a hydrocarbyl group containing 1 to 30 carbon atoms, and v is 0.1 to 3 (such as 1.1 to 3). This formulation represents the observed average of organoaluminium species (as determined by ¹H NMR) present in a mixture, which may include any of Al(R′)₃, Al(R′)₂(R″), Al(R′)(R″)₂, and Al(R″)₃. In still another aspect, the aluminum vinyl-transfer agent has less than 50 wt % dimer present, based upon the weight of the AVTA, such as less than 40 wt %, such as less than 30 wt %, such as less than 20 wt %, such as less than 15 wt %, such as less than 10 wt %, such as less than 5 wt %, such as less than 2 wt %, such as less than 1 wt %, such as 0 wt % dimer. Alternately dimer is present at from 0.1 to 50 wt %, alternately 1 to 20 wt %, alternately at from 2 to 10 wt %. Dimer is the dimeric product of the alkyl diene used in the preparation of the AVTA. The dimer can be formed under certain reaction conditions and is formed from the insertion of a molecule of diene into the Al—R bond of the AVTA, followed by beta-hydride elimination. For example, if the alkyl diene used is 1,7-octadiene, the dimer is 7-methylenepentadeca-1,14-diene. Similarly, if the alkyl diene is 1,9-decadiene, the dimer is 9-methylenenonadeca-1,18-diene.

For polymerizations of the present disclosure, the molar ratio of AVTA to catalyst complex can be greater than 5, alternately greater than 10, alternately greater than 15, alternately greater than 20, alternately greater than 25, alternately greater than 30.

In at least one embodiment of the present disclosure, the metal hydrocarbenyl chain transfer agent is represented by the formula: Al(R′)₃₋ᵥ(R″)ᵥ where each R′ independently is a C₁-C₃₀ hydrocarbyl group, each R″, independently, is a C₄-C₂₀ hydrocarbenyl group having an end-vinyl group, and v is from 0.1 to 3, such as each R″, independently, is a C₄-C₂₀ hydrocarbenyl group having an allyl chain end and v is from 0.1 to 3, such as v=2.

The production of in-chain functionalized ethylene/butadiene copolymers is possible with this technology. Additionally, the process disclosed herein allows for in-chain functionalization of ethylene/butadiene copolymers within a single reactor. The Al-carbon bonds can react with a variety of electrophiles (and other reagents), such as oxygen, halogens, carbon dioxide, and the like to form functionalized vinyl transfer agent units. For example, the Al-carbon bonds react with carbon dioxide to form carbon dioxide functionalized vinyl transfer agent units.

### Tires

In some embodiments, copolymers of the present disclosure can be used as a component of a tire. A tire (also referred to as a “tire product” herein) can be any suitable tire, such as a rubber tire having an outer (visible) rubber sidewall layer where the outer sidewall layer includes a copolymer of the present disclosure. The tire can be built, shaped, molded to include the outer sidewall (rubber sidewall layer) and cured by various methods which will be readily apparent to those having skill in such art.

Blends of highly saturated specialty elastomers blended with highly unsaturated polymers can be desired to improve the performance window of the blend (e.g., oxygen & ozone resistance, thermal stability, tack, etc). For tire tread in particular, tire tread compounds in a tire, dictate properties of the tire, such as wear, traction, and rolling resistance. It is a technical challenge to deliver excellent traction, low rolling resistance while providing good tread wear. The challenge lies in the trade-off between wet traction and rolling resistance/tread wear.

Because a need for filler to be introduced to the ultimate tire product is reduced or eliminated using methods and polymers of the present disclosure, the reduction or absence of filler in the tire product provides improved wear resistance, for example reduced or eliminated cracking initiation and propagation, of the tire product (tire tread).

The term “filler” as used herein refers to any material that is used to reinforce or modify physical properties of a composition (as a tire product), impart certain processing properties, or reduce cost of a tire.

In some embodiments, examples of inorganic filler include calcium carbonate, clay, mica, silica, silicates, talc, titanium dioxide, alumina, zinc oxide, starch, wood flour, or combination(s) thereof. The fillers may be any size and range, for example in the tire industry, from 0.0001 μm to 100 μm.

As used herein, the term “silica” is meant to refer to any type or particle size silica or another silicic acid derivative, or silicic acid, processed by solution, pyrogenic, or the like methods, including untreated, precipitated silica, crystalline silica, colloidal silica, aluminum or calcium silicates, fumed silica, and the like. Precipitated silica can be conventional silica, semi-highly dispersible silica, or highly dispersible silica. A filler can be commercially available by Rhodia Company under the trade name ZEOSIL™ Z1165 or ZEOSIL™ 1165 MP.

Because functionalized copolymers of the present disclosure can provide improved interactions between the copolymer and additive(s), less additive (such as a filler) can be used as compared to conventional tire compositions. In some embodiments, a composition (as a tire product) includes, per 100 parts by weight of rubber (phr), less than 150 phr, such as about 10 to about 150 phr filler (such as silica). In another embodiment, a composition (as a tire product) includes, about 30 to about 130 phr of filler. In a further embodiment, a composition includes, about 50 to about 90 phr filler.

### EXAMPLES

### GPC-4D:

Unless otherwise indicated, the distribution and the moments of molecular weight (Mw, Mn, Mz, Mw/Mn, etc.) and the comonomer content are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering about 2700 cm⁻¹ to about 3000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ~300 ppm antioxidant BHT can be used as the mobile phase at a nominal flow rate of ~1.0 mL/min and a nominal injection volume of ~200 μL. The whole system including transfer lines, columns, and detectors can be contained in an oven maintained at ~145° C. A given amount of sample can be weighed and sealed in a standard vial with ~10 μL flow marker (heptane) added thereto. After loading the vial in the auto-sampler, the oligomer or polymer may automatically be dissolved in the instrument with ~8 mL added TCB solvent at ~160° C. with continuous shaking. The sample solution concentration can be from ~0.2 to ~2.0 mg/ml, with lower concentrations used for higher molecular weight samples. The concentration, c, at each point in the chromatogram can be calculated from the baseline-subtracted IR5 broadband signal, I, using the equation: c=αI, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{α + 1} + \frac{{α}_{PS} + 1}{α + 1} log {M}_{PS}$$

where the variables with subscript “PS” stand for polystyrene while those without a subscript are for the test samples. In this method, α_{PS}=0.67 and K_{PS}=0.000175, α and K for other materials are as calculated by GPC ONE™ software (Polymer Characterization, S.A., Valencia, Spain). Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

$$w 2 = f * SCB / 1000 TC$$

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits}$$

Then the same calibration of the CH₃ and CH₂ signal ratio, as mentioned previously in obtaining the CH3/1000TC as a function of molecular weight, is applied to obtain the bulk CH3/1000TC. A bulk methyl chain ends per 1000TC (bulk CH3end/1000TC) is obtained by weight-averaging the chain-end correction over the molecular-weight range. Then

$$w 2 b = f * bulk CH 3 / 1000 TC$$

$$bulk SCB / 1000 TC = bulk CH 3 / 1000 TC - bulk CH 3 end / 1000 TC$$

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c$$

Here, ΔR(θ) is the measured excess Rayleigh scattering intensity at scattering angle θ, c is the polymer concentration determined from the IR5 analysis, A2 is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}}$$

where NA is Avogadro's number, and (dn/dc) is the refractive index increment for the system, n=1.500 for TCB at 145° C. and λ=665 nm. For analyzing polyethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1−0.00126*w2) ml/mg and A2=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηs, for the solution flowing through the viscometer is calculated from their outputs. The intrinsic viscosity, [η], at each point in the chromatogram is calculated from the equation [η]=ηs/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

Differential Scanning Calorimetry (DSC) measurements were performed on a DSC2500™ (TA Instruments) to determine the glass transition temperature (Tg) and melting point (Tm) of polymers of the present disclosure is as follows. The polymer samples were cooled at a rate of 10° C./min. to −150° C. and held for 10 minutes. The samples were then heated at 10° C./min. to attain a final temperature of 150° C. and held at this temperature for 5 min. Then a second cool-heat cycle was performed, using the same conditions described above. Events from both cycles, “first melt” and “second melt”, respectively, are recorded. Reference to melting point temperature (Tm) and glass transition temperature (Tg) refers to the second melt.

### Synthesis of Catalysts

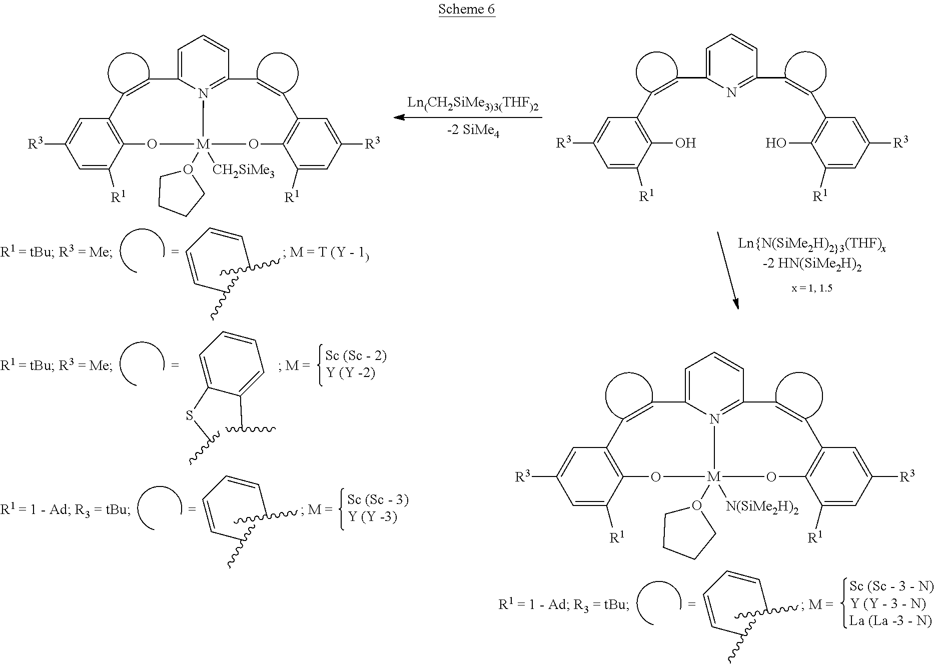

Ln(Me₃SiCH₂)₃(THF)₂ (Ln=Sc, Y, Lu) were synthesized from (trimethylsilyl)methyllithium (0.7M in hexanes; Acros Organics) and anhydrous LnCl₃ (Aldrich) and as described in Chemical Communications 2016, v. 52(31), pp. 5425-5427. Ln(N(SiMe₂H)₂)₃(THF)ₙ (Ln=Sc, Y, La) were prepared as described in literature (Organometallics 2013, v. 32, pp. 1528-1530 and J. Org. Chem. 2007, 72, v. 23, pp. 8648-8655). The ligand precursor, 2′,2′″-(pyridine-2,6-diyl)bis(3-(tert-butyl)-5-methyl-[1,1′-biphenyl]-2-ol), was synthesized as described in WO2020/167824. The ligand precursor, 6,6′-(pyridine-2,6-diylbis(benzo[b]thiophene-3,2-diyl))bis(2-(tert-butyl)-4-methylphenol), was synthesized as described in WO2020/167819. The ligand precursor, 2′,2′″-(pyridine-2,6-diyl)bis(3-(adamantan-1-yl)-5-(tert-butyl)-[1,1′-biphenyl]-2-ol), was synthesized as described in U.S. Pat. No. 11,254,763. Methylaluminoxane was used in the form of 30 wt % solution in toluene (Grace, 13.5 wt % Al, 5 mmol Al/g). Ammonium hexafluorosilicate (NH₄)₂SiF₆ was purchased from Aldrich and dried in vacuo at ambient temperature for 16 hours. Octamethyltrisiloxane (OMTS, Aldrich) was degassed and dried above activated molecular sieves (3 Å) for 16 hours. All other reagents are commercially available, and all solvents were dried and de-gassed prior to use using typical methods previously reported. Metal complexes, also referred to as catalysts, and pre-catalysts, were prepared under an inert atmosphere as shown in Scheme 6.

### Example 1. Synthesis of Complex Y-1

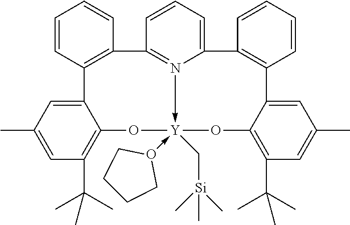

In a 20 ml scintillation vial, to a suspension of 204 mg (0.368 mmol) of 2′,2′″-(pyridine-2,6-diyl)bis(3-(tert-butyl)-5-methyl-[1,1′-biphenyl]-2-ol) in 10 ml of hexane, 182 mg of Y(Me₃SiCH₂)₃(THF)₂ (0.368 mmol) was added in one portion at −30° C. The resulting mixture was stirred at room temperature for 6 hours, and the vial was brought to fridge (−30° C.). After 12 hours, the precipitate was filtered off using a syringe filter (0.45 um PTFE), and the mother liquor was put back into the fridge. After 12 hours, the precipitate formed was filtered off using a syringe filter (0.45 um PTFE), and the mother liquor was evaporated to dryness to give 145 mg (49%) of the product as a beige powder. Anal. Calc. for C₄₇H₅₈YNO₃Si: C, 70.39; H, 7.29; N, 1.75. Found: C, 70.65; H, 7.68; N, 1.51. ¹H NMR (400 MHz, benzene-d₆): δ 7.53 (dd, J=7.5, 1.3 Hz, 1H), 7.18-7.38 (m, 6H), 6.94-7.06 (m, 4H), 6.88 (dd, J=7.8, 1.1 Hz, 1H), 6.66 (d, J=2.3 Hz, 1H), 6.52 (t, J=7.8 Hz, 1H), 6.32 (dd, J=7.8, 1.1 Hz, 1H), 3.69-3.75 (m, 2H), 3.57-3.63 (m, 2H), 2.28 (s, 3H), 2.20 (s, 3H), 1.67 (s, 9H), 1.56 (s, 9H), 1.11-1.14 (m, 4H), 0.27 (s, 9H), −0.41 (dd, J=11.4, 3.9 Hz, 1H), −2.05 (dd, J=11.4, 4.0 Hz, 1H).

### Example 2. Synthesis of Complex Sc-2

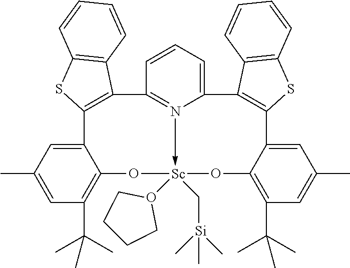

In a 20 ml scintillation vial, to a suspension of 170 mg (0.255 mmol) of 6,6′-(pyridine-2,6-diylbis(benzo[b]thiophene-3,2-diyl))bis(2-(tert-butyl)-4-methylphenol) in 10 ml of hexane and 0.5 ml of toluene, 115 mg of Sc(Me₃SiCH₂)₃(THF)₂ (0.255 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the precipitate was filtered off using a syringe filter (0.45 um PTFE), and the mother liquor was evaporated to dryness to yield 127 mg (57%) of the product as an off-white solid. Anal. Calc. for C₅₁H₅₈ScNS₂O₃Si: C, 70.39; H, 6.72; N, 1.61. Found: C, 70.68; H, 6.98; N, 1.50. ¹H NMR (400 MHz, benzene-d6): δ 7.73 (d, J=8.0 Hz, 1H), 7.55 (d, J=8.0 Hz, 1H), 7.51 (d, J=8.0 Hz, 1H), 7.40 (d, J=1.7 Hz, 1H), 7.31 (dt, J=7.2, 1.0 Hz, 1H), 7.15-7.21 (m, 2H), 7.00-7.14 (m, 5H), 6.91 (dt, J=8.0, 1.0 Hz, 1H), 6.79 (t, J=7.8 Hz, 1H), 6.22 (dd, J=7.7, 1.1 Hz, 1H), 6.11 (d, J=7.8 Hz, 1H), 4.10-4.17 (m, 2H), 3.97-4.05 (m, 2H), 2.25 (s, 3H), 2.21 (s, 3H), 1.50 (s, 9H), 1.15-1.24 (m, 4H), 0.98 (s, 9H), 0.17 (d, J=11.3 Hz, 1H), 0.12 (s, 9H), −1.59 (d, J=11.3 Hz, 1H). ¹³C NMR (400 MHz, benzene-d6): δ 162.6, 159.5, 156.9, 154.3, 151.0, 145.0, 142.9, 141.5, 140.0, 139.7, 139.6, 139.1, 136.8, 132.6, 130.6, 130.2, 129.7, 129.6, 126.0, 125.97, 125.6, 125.4, 125.3, 124.9, 124.2, 124.1, 123.6, 123.5, 123.2, 122.8, 122.3, 72.7, 35.9, 35.3, 30.1, 29.5, 25.2, 21.8, 21.3, 4.1.

### Example 3. Synthesis of Complex Y-2

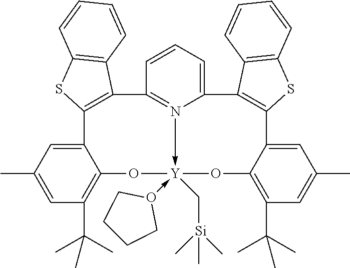

In a 20 ml scintillation vial, to a suspension of 135 mg (0.202 mmol) of 6,6′-(pyridine-2,6-diylbis(benzo[b]thiophene-3,2-diyl))bis(2-(tert-butyl)-4-methylphenol) in 10 ml of hexane and 0.5 ml of toluene, 100 mg of Y(Me₃SiCH₂)₃(THF)₂ (0.202 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the formed precipitate was filtered off using a syringe filter (0.45 um PTFE), and the mother liquor was evaporated to dryness to yield 124 mg (67%) of the product as an off-white solid. Anal. Calc. for C₅₁H₅₈YNS₂O₃Si: C, 67.01; H, 6.40; N, 1.53. Found: C, 66.85; H, 6.65; N, 1.31. ¹H NMR (400 MHz, benzene-d6): δ 7.61 (d, J=7.9 Hz, 1H), 7.55 (d, J=7.9 Hz, 1H), 7.51 (d, J=7.9 Hz, 1H), 7.36 (d, J=2.0 Hz, 1H), 7.28 (dt, J=7.5, 1.1 Hz, 1H), 7.17-7.21 (m, 2H), 6.93-7.10 (m, 5H), 6.77 (t, J=7.8 Hz, 1H), 6.28 (dd, J=7.7, 1.1 Hz, 1H), 6.21 (d, J=7.7 Hz, 1H), 3.80-3.93 (m, 4H), 2.26 (s, 3H), 2.22 (s, 3H), 1.48 (s, 9H), 1.09-1.15 (m, 4H), 1.05 (s, 9H), 0.19 (s, 9H), −0.59 (dd, J=11.3, 3.9 Hz, 1H), −2.18 (dd, J=11.3, 4.0 Hz, 1H). ¹³C NMR (400 MHz, benzene-d6): δ 162.9, 160.1, 156.9, 153.8, 152.0, 145.8, 142.6, 141.7, 140.2, 139.6, 139.4, 136.9, 130.6, 130.3, 130.1, 130.0, 129.6, 126.2, 125.8, 125.6, 125.5, 124.9, 124.6, 124.3, 123.6, 123.5, 123.2, 123.1, 122.8, 122.7, 122.2, 72.0, 35.8, 35.3, 30.4, 30.2, 29.9, 29.5, 25.2, 21.34, 21.31, 4.6.

### Example 4. Synthesis of Complex Sc-3

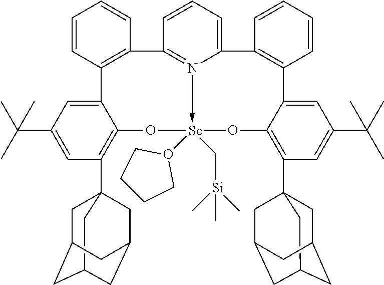

In a 20 ml scintillation vial, to a suspension of 526 mg (0.660 mmol) of 2′,2′″-(pyridine-2,6-diyl)bis(3-(adamantan-1-yl)-5-(tert-butyl)-[1,1′-biphenyl]-2-ol) in 40 ml of hexane and 6.5 ml of toluene, 294 mg of Sc(CH₂SiMe₃)₃(THF)₂ (0.660 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the precipitate was filtered off using a syringe filter (0.45 um PTFE), and the mother liquor was evaporated to give 103 mg (15%) of the product as an off-white solid. Anal. Calc. for C₆₅H₈₂ScNO₃Si: C, 78.20; H, 8.28; N, 1.40. Found: C, 78.42; H, 8.61; N, 1.26. ¹H NMR (400 MHz, benzene-d6): δ 7.67 (d, J=7.2 Hz, 1H), 7.66 (d, J=2.8 Hz, 1H), 7.53 (d, J=2.7 Hz, 1H), 7.39-7.47 (m, 3H), 7.34 (d, J=7.1 Hz, 1H), 7.30 (d, J=2.7 Hz, 1H), 7.19-7.22 (m, 2H), 7.04-7.08 (m, 1H), 6.86-6.90 (m, 2H), 6.65 (t, J=7.8 Hz, 1H), 6.36 (dd, J=7.7, 1.0 Hz, 1H), 3.98-4.06 (m, 2H), 3.68-3.74 (m, 2H), 2.66-2.73 (m, 3H), 2.43-2.63 (m, 6H), 2.30-2.39 (m, 6H), 2.27 (br.s, 3H), 2.14-2.22 (m, 3H), 1.90-2.12 (m, 9H), 1.46 (s, 9H), 1.34 (s, 9H), 1.20-1.28 (m, 4H), 0.31 (s, 9H), 0.14 (d, J=11.4 Hz, 1H), −1.88 (d, J=11.5 Hz, 1H). ¹³C NMR (400 MHz, benzene-d6): δ 161.8, 159.3, 158.3, 158.1, 145.9, 144.5, 138.6, 138.5, 137.7, 137.2, 136.7, 136.0, 135.8, 133.2, 131.7, 131.3, 130.9, 130.8, 130.2, 129.9, 129.7, 127.1, 126.7, 126.0, 125.2, 124.9, 124.0, 123.8, 122.0, 73.1, 42.8, 41.3, 38.7, 38.3, 38.1, 37.8, 34.7, 34.5, 32.5, 32.3, 30.23, 30.18, 25.4, 4.5.

### Example 5. Synthesis of Complex Y-3

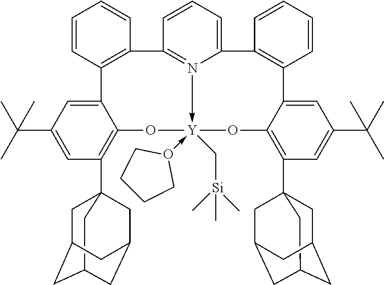

In a 20 ml scintillation vial, to a suspension of 101 mg (0.127 mmol) of 2′,2′″-(pyridine-2,6-diyl)bis(3-(adamantan-1-yl)-5-(tert-butyl)-[1,1′-biphenyl]-2-ol) in 20 ml of n-hexane and 1.5 ml of toluene, 63 mg of Y(Me₃SiCH₂)₃(THF)₂ (0.127 mmol) was added in one portion at room temperature. The resulting solution was stirred at room temperature for 12 hours, and the vial was brought to fridge (−30° C.). After 12 hours, the precipitate was filtered off using a syringe filter (0.45 um PTFE), and the mother liquor was put back in the fridge. After 12 hours, the precipitate was filtered off using a syringe filter (0.45 um PTFE), and the mother liquor was evaporated to yield 110 mg (83%) of the product as an off-white solid. Anal. Calc. for C₆₅H₈₂YNO₃Si: C, 74.90; H, 7.93; N, 1.34. Found: C, 75.27; H, 8.12; N, 1.19. ¹H NMR (400 MHz, benzene-d6): δ 7.62 (d, J=7.6, 1.0 Hz, 1H), 7.52 (d, J=2.7 Hz, 1H), 7.41 (d, J=2.7 Hz, 1H), 7.37 (dt, J=7.5, 1.5 Hz, 1H), 7.25-7.34 (m, 5H), 7.23 (d, J=2.7 Hz, 1H), 6.97-7.13 (m, 6H), 6.80-6.82 (m, 2H), 6.58 (t, J=7.8 Hz, 1H), 6.32 (dd, J=7.8, 1.0 Hz, 1H), 3.65-3.72 (m, 2H), 3.42-3.50 (m, 2H), 2.60-2.67 (m, 3H), 2.49-2.56 (m, 3H), 2.34-2.41 (m, 3H), 2.16-2.28 (m, 9H), 2.04-2.11 (m, 3H), 1.85-1.93 (m, 9H), 1.38 (s, 9H), 1.26 (s, 9H), 1.04-1.11 (m, 4H), 0.26 (s, 9H), −0.63 (dd, J=11.3, 3.8 Hz, 1H), −2.03 (dd, J=11.3, 3.9 Hz, 1H).

### Example 6. Synthesis of Complex Sc-3-N

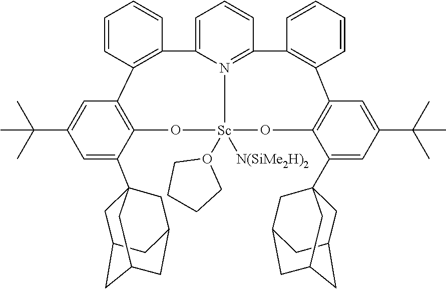

In a 20 mL scintillation vial, [Sc{N(SiMe₂H)₂}₂]·THF (207 mg, 0.4 mmol) was dissolved in 2 mL of THF. Then, solid 2′,2′″-(pyridine-2,6-diyl)bis(3-(adamantan-1-yl)-5-(tert-butyl)-[1,1′-biphenyl]-2-ol) (312 mg, 0.39 mmol) was slowly added while stirring at ambient temperature. After the addition, the reaction mixture was diluted by adding 3 mL THF. The resulting mixture was stirred at 60° C. for 2 hours before the volatiles were removed under nitrogen stream. n-Pentane (5 mL) was added to the pale-yellow oily residue and evaporated to facilitate removing of residual THF. This process was repeated twice to give a pale-yellow powder, which was dissolved in n-pentane (5 mL) and filtered. The filtrate was concentrated to ca ⅕ of the original volume and cooled to −35° C. White crystals were decanted off and dried in vacuum to give 129 mg (33%) of the desired product. The broadness of the resonance signals in ¹H NMR spectrum precludes their accurate integration. ¹H NMR (400 MHz, benzene-d₆): δ 7.47 (d, J=2.7 Hz, 2H), 7.43 (d, J=2.8 Hz, 2H), 7.30-7.11 (m, 6H), 7.01-6.95 (m, 2H), 6.55-6.49 (m, 3H), 4.34 (m, 2H, Si—H), 3.62 (s, 4H, THF), 2.45-2.42 (m, 6H), 2.26-2.21 (m, 12H), 1.97-1.85 (m, 14H), 1.36-1.35 (m, 4H), 1.30 (s, 18H, C(CH₃)₃), 0.20 (d, J=10.8 Hz, 12H, SiMe₂).

### Example 7. Synthesis of Complex Y-3-N

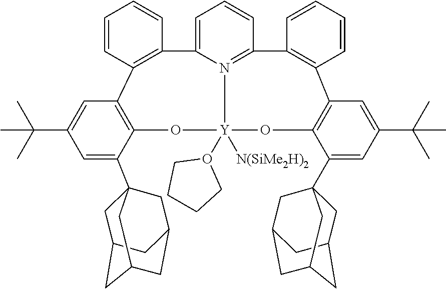

In a 20 mL scintillation vial, [Y{N(SiMe₂H)₂}2]·1.5THF (235 mg, 0.39 mmol) was dissolved in 2 mL of THF. Then, solid 2′,2′″-(pyridine-2,6-diyl)bis(3-(adamantan-1-yl)-5-(tert-butyl)-[1,1′-biphenyl]-2-ol) (305 mg, 0.38 mmol) was slowly added while stirring at ambient temperature. After the addition, the reaction mixture was diluted by adding 3 mL THF. The resulting mixture was stirred at 60° C. for 2 hours before the volatiles were removed under nitrogen stream. n-Pentane (5 mL) was added to the pale-yellow oily residue and evaporated to facilitate removing of residual THF. This process was repeated twice to give a pale-yellow powder which was dissolved in toluene (1 ml). The resulting solution was layered with n-pentane and stored at −35° C. The precipitated white solid product was collected by filtration and washed twice with cold n-pentane (0.5 mL each). It was then dried in vacuo under a gentle heating (below 40° C.) to give 273 mg of the white solid product (64%). ¹H NMR (400 MHz, benzene-d6): δ 7.48-7.33 (m, 5H), 7.25-7.00 (m, 6H), 6.85-6.75 (m, 2H), 6.54 (t, 7.5 Hz, 1H) 6.28 (m, 1H), 4.45 (s, 2H, SiH), 3.74-3.45 (m, 4H), 2.61-2.44 (m, 6H), 2.26-2.11 (m, 11H), 1.98 (m, 6H), 1.88-1.85 (m, 7H), 1.37-1.15 (m, 22H), 0.26 (dd, J=18.7 and 2.1 Hz, 12H, SiMe₂).

### Example 8. Synthesis of Complex La-3-N

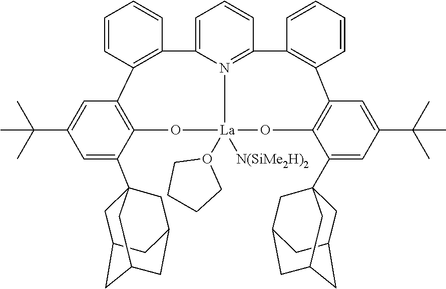

In a 20 mL scintillation vial, [La{N(SiMe₂H)₂}2]·1.5THF (243 mg, 0.35 mmol) was dissolved in 2 mL of THF. Then, solid 2′,2′″-(pyridine-2,6-diyl)bis(3-(adamantan-1-yl)-5-(tert-butyl)-[1,1′-biphenyl]-2-ol) (273 mg, 0.34 mmol) was slowly added while stirring at ambient temperature. After the addition, the reaction mixture was diluted by adding 3 mL THF. The resulting mixture was stirred at 60° C. for 2 hours before the volatiles were removed under nitrogen stream and heating at 60° C. n-Pentane (5 mL) was added to the pale-yellow oily residue and evaporated to facilitate removing of residual THF and HN(SiMe₂H)₂. This process was repeated five times to give a pale-yellow powder which was washed twice with n-pentane (7 ml each). The resulting product was dissolved in toluene (3 ml) and the obtained solution was subsequently passed through glass microfiber filter and a plug of celite. Concentrating of the filtrate to ca 0.5 mL and layering with n-pentane at −35° C. afforded the precipitation of yellow crystals which were collected by decanting and dried in vacuo for 4 hours to give 297 mg of the product (70%). ¹H NMR (400 MHz, benzene-d6): δ 7.43-7.40 (m, 4H), 7.29-7.11 (m, 6H), 7.06-6.98 (m, 2H), 6.61-6.54 (m, 3H), 4.48 (sept, 2.9 Hz, 2H, SiH), 3.46 (s, 4H, THF), 2.46-2.16 (m, 18H), 2.02-1.99 (m, 6H), 1.90-1.87 (m, 6H), 1.32 (s, 18H, tBu), 1.16-1.13 (m, 4H), 0.26 (dd, J=22.4 and 3.0 Hz, 12H, SiMe₂).

### Example 9. TMA free F-MAO

Reaction: (NH₄)₂SiF₆+8 AlMe₃=2/6 [(AlMeNH)₃]₂+6 AlMe₂F+SiMe₄+6 CH₄

Ammonium hexafluorosilicate (NH₄)₂SiF₆ (0.66 g, 3.7 mmol) was slowly added to the commercial solution of MAO in toluene (30 wt % MAO, 40 g, 200 mmol Al). The resulting mixture was shaken for 1 hour to give the solution of F-MAO.

### Example 10. TMA free Ionic MAO

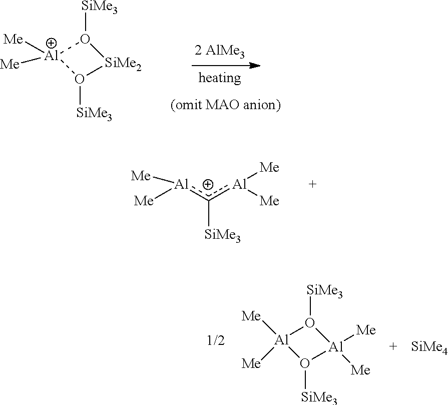

Octamethyltrisiloxane (OMTS) (4.80 g, 20.3 mmol) was added to the commercial solution of MAO in toluene (109.0 g, 30 wt % MAO, 545 mmol Al) and the resulting mixture was stirred for 45 minutes at ambient temperature. Then, the solution was transferred to a separation funnel and allow to settle for 16 hours before two liquid layers were separated. The bottom layer (51 g, oil) was heated at 90° C. for 1 hour to facilitate the conversion of low activity chelating AlMe₂(OMTS)⁺ cation into the active monodentate coordinated [(AlMe₂)₂(OSiMe₃)]⁺ species. Ionic MAO is also referred to as I-MAO.

### Example 11. Quantification of Total THF Extractable TMA Contents in the MAO

Solution. The total TMA content including the coordinated and free TMA in MAO composition can be quantified through a THF solvent treatment to convert both the coordinated and free TMA to AlMe₃(THF) as the major product and AlMe₂(THF)₂⁺ as a minor product according to Scheme 7. The total TMA is therefore the sum of AlMe₃(THF) and AlMe₂(THF)₂⁺ (converted back to TMA in calculation) and can be quantified with the ¹H NMR methods below with the solvent toluene as the internal standard for solution MAO or with an added inert compound as the internal standard for either a solution MAO, a solid MAO, or a supported MAO.

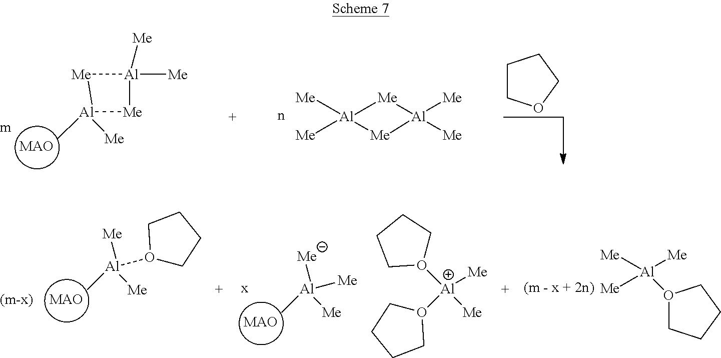

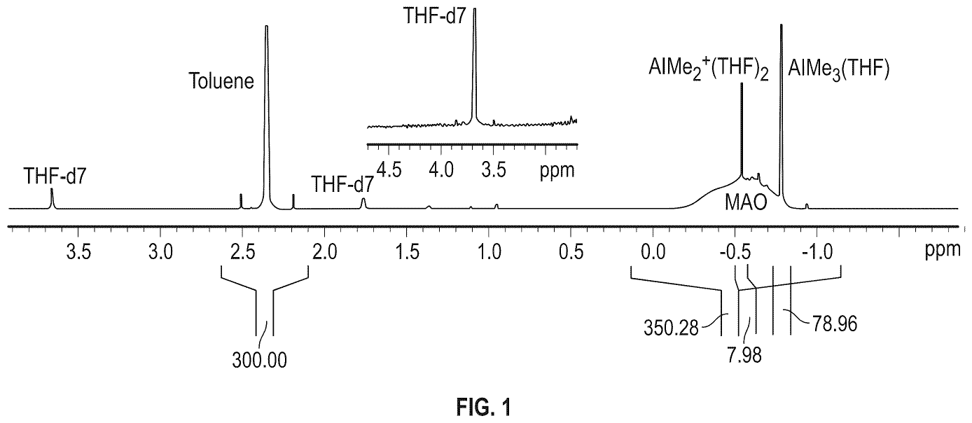

Procedure: In the drybox, fill an oven dried 5 mm NMR tube with ~0.5 inch MAO solution, followed by adding ~1.5 inch THF-d₈ solvent, shake well, and then take the H NMR spectrum of the sample using D1=30 s, ns=4. A longer relaxation time D1 may be more accurate but 30 s is long enough to obtain <2 wt % error of quantitative toluene CH₃ and Al—CH₃ signals. The ¹H NMR spectrum in the region from toluene Me to Al-Me for commercial MAO solution (W. R. Grace MAO 30% toluene solution (Al=13.6 wt % (5.0 mmol/g), MAO=26.6 wt %, total TMA (coordinated and free)=4.76 wt % from the Certificate of Analysis (COA) of the MAO product)) is shown in FIG. 1.

Processing: integrate the peak of CH₃ on toluene, the total Al—CH₃ area, the peak of AlMe₂(THF)₂⁺, and the peak of AlMe₃(THF); set the integral of CH₃ of toluene as 300 (set as 300 instead of 3, the CH₃ proton number, in order to have at least 3 digit accuracy in the spectrum printout because the numbers after the decimal point may be cut off) and record all Al-Me species integral including MAO, AlMe₃(THF) and AlMe₂(THF)₂⁺ as 350.28, AlMe₃(THF) integral as 78.96 AlMe₂(THF)₂⁺ integral as 7.98, and ignore minor species such as the processing oil that is usually present but in small amount, e.g., <1 wt %. The MAO formula without coordinated TMA is Al₁O_{0.78}Me_{1.44} based on the COA to give a Mw 61.1. The MAO integral is 350.28-78.96-7.98=263.34. The proton number in MAO is 1.44*3=4.32. The AlMe₂⁺ is counted as TMA because it is generated from coordinated TMA. The calculation results are listed in Table 1.

TABLE 1
Total THF extractable TMA Calculation

| | | | | Weight | | |
|---|---|---|---|---|---|---|
| Species | Integral | Proton# | Mw | Portion¹ | Wt %² | Total TMA |
| Toluene | 300 | 3 | 92.1 | 9210 | 67.40 | |
| MAO | 263.34 | 4.32 | 61.1 | 3726.3 | 27.27 | |
| AlMe₃ | 78.96 | 9 | 72.1 | 632.6 | 4.63 | 5.33% |
| AlMe₂⁺ | 7.98 | 6 | 72.1³ | 95.9 | 0.70 | |
| | | | Total | 13664.8 | 100 | |

¹Weight portion, = Mw*Integral/Proton#, is an individual species' weight contribution;
²wt % = individual weight portion/total weight portions*100%;
³AlMe₂⁺ is derived from the coordinated TMA and therefore is converted back to TMA.

It can be seen that now the total TMA content is increased from 4.76 wt % (COA) to 5.33 wt %, an indication of low degree gelation.

### Example 12. Quantification of Coordinated TMA in a Commercial MAO Solution

The quantification of coordinated TMA is based on the reaction (Scheme 8) below:

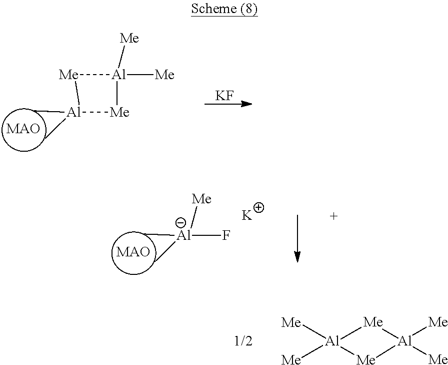

In the reaction above, KF can precipitate MAO as a clathrate phase to separate from the solution phases containing free TMA through the replacement of the coordinated TMA to form an ionic MAO composition. Applying a largely excess, known amount of KF (W1^{KF}) to an MAO solution and isolating the left KF (W2^{KF}) after the reaction, the KF consumption can be calculated as W1^{KF}-W2^{KF}, which is an indirect quantification method for the coordinated TMA content.

Chemicals: KF (Aldrich), 10 g in a 50 mL round bottom flask dried in an oil bath at 110° C. under vacuum for 4 hour; the same MAO solution and THF-d8 used for Example 11.

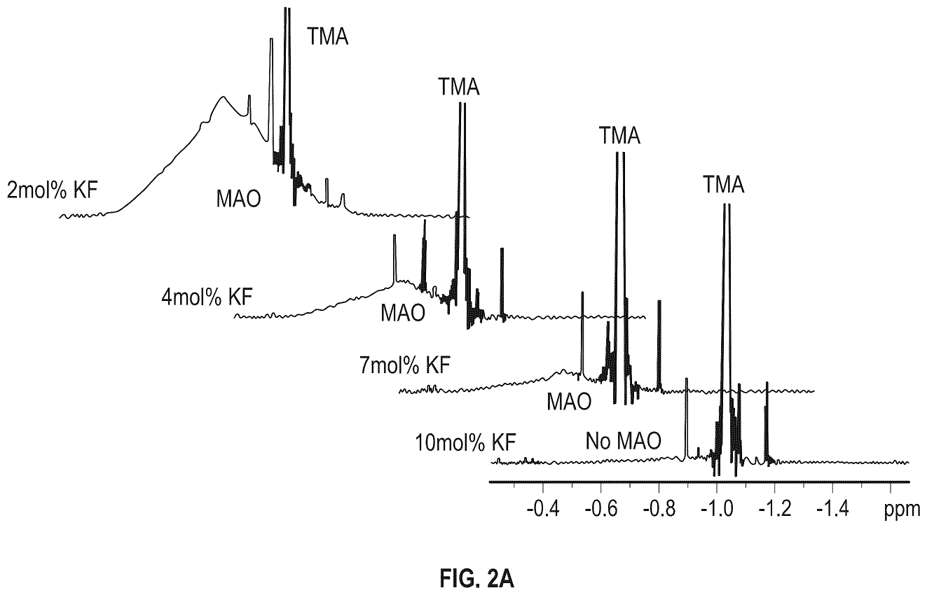

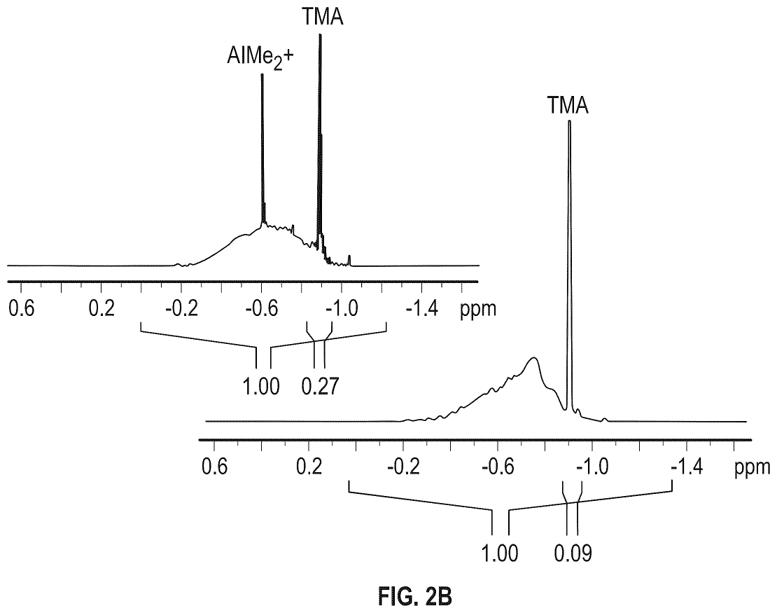

Procedure: In the drybox, each of 4 oven-dried vials (20 mL) were charged with 10.0 g MAO solution (51.1 mmol Al calculated based on Table 1 results), and then with KF (58.1 g/mol) 59.6 mg (2 mol % based on total Al), 118.9 mg (4 mol % based on total Al), 207.6 mg (7 mol % based on total Al), and 298 mg (10 mol % based on total Al), respectively. Place the vials on a shaker to shake for overnight. Remove the vials from the shaker and allow the clathrate phases to settle for 10 hour. KF in vials with 2 mol %, 4 mol %, and 7 mol % treatment all disappeared but the vial with 10 mol % treatment showed left-over KF. All upper phase solutions of the 4 vials were analyzed with ¹H NMR spectroscopy in THF-d₈ NMR solvent and the spectra were compared in the Al-Me region shown in FIG. 2A that shows reducing MAO concentrations. The clathrate phase from the sample with complete conversion of regular MAO to ionic MAO (vial with 10 mmol % KF treatment) was also analyzed with ¹H NMR spectroscopy in THF-d₈ NMR solvent and the spectrum of the Al-Me region is shown in FIG. 2B with the mother MAO solution for comparison, which shows the absence of AlMe₂⁺ species for the ionic MAO, meaning all coordinated TMA is removed by KF as a confirmation that the coordinated TMA is the source of AlMe₂⁺. The left-over KF in the vial of 10 mol % treatment was collected with a pre-weighted frit filter, which was washed with 3×10 mL dried toluene and 30 mL dried isohexane, then weighted to give 75.3 mg (2.54 mol % based on total Al) unreacted KF, giving the coordinated TMA in the MAO solution=10-2.5=7.5 mol %. The total Al % is 13.8 wt % and the total TMA (free+coordinated) is 5.33 wt %. The total TMA can be converted to 2.00 wt % Al to give 14.5 mol %.

FIGS. 2A-B. ¹H NMR spectra of a 30% commercial MAO solution after KF treatment; with FIG. 2A showing the upper solution phases after 2, 4, 7, and 10 mol % KF treatment, respectively; and with FIG. 2B showing the final K⁺(F-MAO)⁻ clathrate phase and the non-treated solution MAO for comparison.

Example 13. Free TMA Estimation. Based on the quantification method for the weight percent of total TMA (Wt^{total TMA}%, coordinated TMA and free TMA) in Example 12 and the quantification method for the weight percent of coordinated TMA (Wt^{coordinated TMA} %) in Example 13, the free TMA content Wt^{free TMA} % can be estimated as Wt^{free TMA}%=Wt^{total TMA} %−Wt^{coordinated TMA} %.

### Example 14. Polymerization Reactions

All manipulations with air- and moisture sensitive materials were carried out under inert atmosphere in the N₂-vented glovebox. Catalysts were activated upon addition of iBu₂AlH (DIBAL) and dimethylanilinium tetrakispentafluorophenylborate (DIMAH-D4), or MAO (13 wt % Al in toluene, 100 eq.), or F-MAO (100 eq., Example 9) or Ionic MAO (10 eq., Example 10). After catalysts and activators were stirred for about 10 minutes, the solution of butadiene in toluene (10 wt %-20 wt %) was added (~2500 butadiene eq/catalyst) and then the reactor equipped with six 20 mL vials was sealed. The reactor was heated to 100° C., stirred at 225 rpm, and then pressurized with ethylene (250 psi, Sigma, 99.5%). The reactor was repressurized when the pressure dropped below 240 psi during the first hour. After 4-14 hours the reactor was cooled and then depressurized. For the isolation of polymer products, the contents of each vial were precipitated and washed with acetone and methanol. Then the solids were filtered out and washed with copious acetone and methanol. The polymer samples were then dried in a 50° C. vacuum oven for 18 hours.

### NMR Studies:

### ¹³C NMR

Samples were dissolved in deuterated 1,1,2,2-tetrachloroethane (tce-d2) at a concentration of 34 mg/mL at 140° C. Spectra were recorded at 120° C. using a Bruker NMR spectrometer of at least 600 MHz with a 10 mm cryoprobe. A 90° pulse, 10 s delay, 512 transients, and gated decoupling were used for measuring the ¹³C NMR spectra. Polymer resonance peaks are referenced to polyethylene main peak at 29.98 ppm. Assignments of the spectra were based on the following literature references: Llauro et.al. Macromolecules, 34, 18, (2001), 6304-6311; Makhiyanov Polymer Sci, (2012), 60-90 and Longo et.al. Macromolecules, v. 36, (2003), pp. 9067-6074.

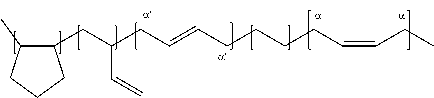

### Calculations of Composition Used the Following Signals:

| | Chemical Shifts | | | |
|---|---|---|---|---|
| Assignment | (ppm) | | Calculations | Mole % |
| C5 ring (cC5) | 46.4, 35.7, 24.3 | | cC5 = (46.4 + 35.5 + 24.3)/5 | cC5/total moles*100 |
| 1,2 butadiene CH | 43.3 | ppm | 1,2 | 1,2/total moles*100 |
| Trans 1,4 butadiene (α′ position) | 32.5 | ppm | trans = α′ position/2 | trans/total moles*100 |
| Cis 1,4 butadiene (α position) | 27.5 | ppm | cis = α position/2 | cis/total moles*100 |
| Ethylene | 28-30 | ppm | E = (28-30)/2 | E/total moles*100 |

| | |
|---|---|
| Total Mole | cC5 + 1,2 + trans + cis + E |

### ¹H NMR

Samples were dissolved in deuterated 1,1,2,2-tetrachloroethane (tce-d2) at a concentration of at least 30 mg/mL at 140° C. Spectra were recorded at 120° C. using a Bruker NMR spectrometer of at least 600 MHz with a 10 mm cryoprobe. A 30° pulse, 5 s delay, and 512 transients, were used for measuring the ¹H NMR. Peaks were referenced to the residual solvent peak at 5.98 ppm.

| | Chemical | | | | |
|---|---|---|---|---|---|
| Assignment | Shifts (ppm) | | Name | Calculations | Mole % |
| 1,2 butadiene CH db | 5.5-5.6 | ppm | 1,2 | 1,2 | 1,2/total moles*100 |
| 1,4 butadiene CH db | 5.30-5.45 | ppm | 1,4 | 1,4 | 1,4/total moles*100 |
| Ethylene | 3-0 | ppm | Aliph | E = (Aliph-4*1,4 − 3*1,2)/4 | E/total moles*100 |

| | |
|---|---|
| Total Mole | 1,2 + 1,4 + E |

### Catalysts Tested

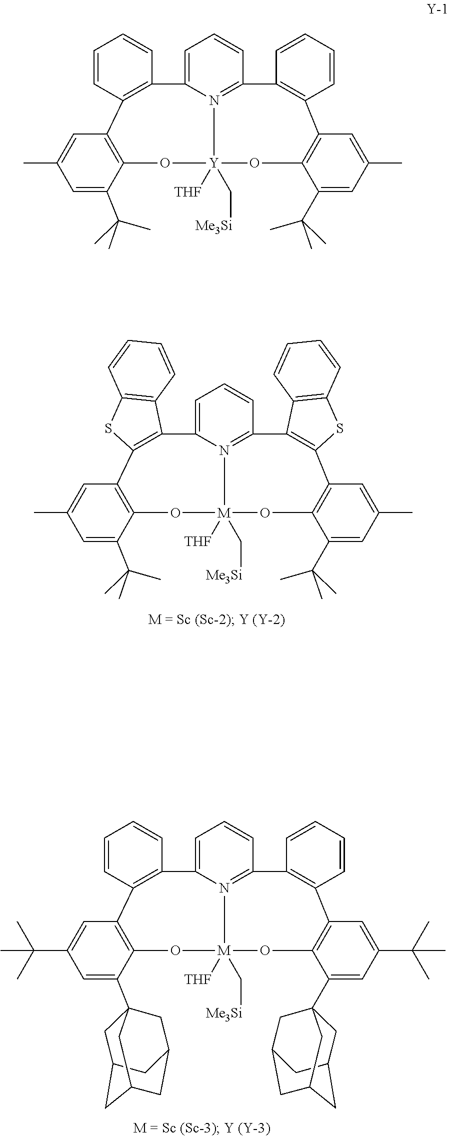

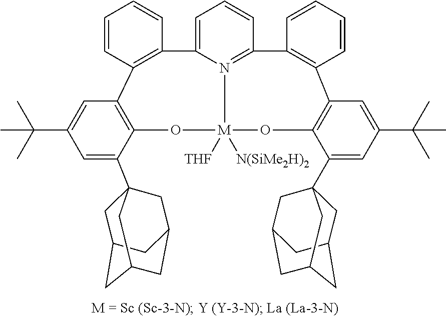

Bis(phenolate)-catalysts Y-1, Sc-2 and Y-2 (Y-1 being derived from Formula II and Sc-2 and Y-2 being derived from Formula III), featuring 2-tBu-4-Me-phenolate fragments and alkyl groups connected to the metal center, were activated by DIMAH-D4/DIBAL, MAO and F-MAO. Interestingly, no product was formed upon activation the copolymerization reaction mixture by DIMAH-D4/DIBAL activator (Table 2, runs 1, 4 and 7). The formation of ethylene-rich copolymers in low yields (up to 43.5 kg_{product}/mol_{RE}) was observed for the MAO-activated reaction mixtures (runs 2, 5 and 8). The activity of the systems Y-1, Sc-2 and Y-2 can be significantly boosted to up to 239.4 kg_{product}/mol_{M} when F-MAO is employed (runs 3, 6 and 9).

TABLE 2
Polymerization data for bis(phenolate)-catalysts Y-1, Sc-2 and Y-2.*

| | | | | BD | | |
|---|---|---|---|---|---|---|
| | | | Activity | (1,4/1,2), | M_{w}, | |
| Run | Cat | Activator | (kg/mol_{M}) | mol % | kDa | PDI |
| 1 | Y-1 | DIMAH-D4 (1.2 eq)/DIBAL | 0 | | | |
| | | (20 eq) | | | | |
| 2 | Y-1 | MAO (100 eq) | 43.5 | (0.7/0.4) | | |
| 3 | Y-1 | F-MAO (100 eq) | 239.4 | (0.1/0.1) | 163 | 2.93 |
| 4 | Sc-2 | DIMAH-D4 (1.2 eq)/DIBAL | 0 | | | |
| | | (20 eq) | | | | |
| 5 | Sc-2 | MAO (100 eq) | 25.0 | | 414 | 21.11 |
| 6 | Sc-2 | F-MAO (100 eq) | 103.4 | | 187 | 3.49 |
| 7 | Y-2 | DIMAH-D4 (1.2 eq)/DIBAL | 0 | | | |
| | | (20 eq) | | | | |
| 8 | Y-2 | MAO (100 eq) | 5.5 | (0.1/0.3) | | |
| 9 | Y-2 | F-MAO (100 eq) | 174 | (0.4/0.2) | 123 | 2.76 |

*Conditions: ca 1 g 1,3-butadiene (BD), toluene solution, BD: M = 2500 molar ratio where M is the group 3 or lanthanide metal; 250 psi ethylene; 100° C.; 14 hours; 1.5 eq. DIMAH-D4/44 eq. DIBAL or 100 eq. MAO or F-MAO.

Bis(phenolate)-catalysts M-3 and M-3-N(derived from Formula II) bearing alkyl or amido auxiliary groups and a central Group III metal ion were activated by DIMAH-D4/DIBAL, MAO and ionic MAO (Table 3). For all M-3 and M-3-N complexes the activity is notably higher when the copolymerization reaction is initiated by ionic MAO. The highest activity was observed for scandium complex Sc-3 (featuring 2-(1-adamantyl)-4-tBu-phenolate fragments) in combination with ionic MAO (run 3, 337 kg_{polymer}/mol_{M}), however, a cross-linked polymer was formed as a main polymerization product. It is worth mentioning that MAO or ionic MAO activators favor the formation of 1,2-cyclopentane units in the polymer chain.

TABLE 3
Polymerization data for catalysts M-3 and M-
3-N activated by MAO, Ionic MAO and DIMAH-D4.

| | | | Activity | | BD (vinyl/1,4- | | | |
|---|---|---|---|---|---|---|---|---|
| | | | (kg_{polymer}/ | C₂, | trans/1,4-cis), | M_{w}, | | |
| Run | Catalyst | Activator | mol_{M}) | mol % | cC₅**, mol % | kDa | PDI | DSC |
| 1 | Sc-3 | DIMAH-D4 | 285 | 74 | (3/5/19), 0 | 306 | 65.60 | Tₘ 127° C., |
| | | (1.2 eq) / | | | | | | T_{g} −101° C. |
| | | DIBAL | | | | | | |
| | | (20 eq) | | | | | | |
| 2 | Sc-3 | MAO | 252.4 | 81 | (1/8/2), 7 | | | Tₘ 100° C. |
| | | (100 eq) | | | | | | |
| 3 | Sc-3 | Ionic MAO | 337.3 | Cross-linked | | | | Tₘ 100° C. |
| | | (10 eq) | | | | | | |
| 4 | Y-3 | DIMAH-D4 | 22.6 | 99 | Vinyl 0.3%, | 222 | 4.1 | |
| | | (1.2 eq) / | | | 1,4-insertion | | | |
| | | DIBAL | | | 0.7% | | | |
| | | (20 eq) | | | | | | |
| 5 | Y-3 | MAO | 185.8 | 94 | (1/0/1), 5 | | | Tₘ 98° C. |
| | | (100 eq) | | | | | | |
| 6 | Y-3 | Ionic MAO | 241.5 | Cross-linked | | | | Tₘ 101° C. |
| | | (10 eq) | | | | | | |
| 7 | Sc-3-N | DIMAH-D4 | 45.7 | 74 | (3/3/20), 0.4 | 371 | 16.92 | |
| | | (1.2 eq) / | | | | | | |
| | | DIBAL | | | | | | |
| | | (20 eq) | | | | | | |
| 8 | Sc-3-N | MAO | 135.4 | | | 1011 | 6.31 | Tₘ 88, 113° C. |
| | | (100 eq) | | | | | | |
| 9 | Sc-3-N | Ionic MAO | 163.2 | | | 5478 | 5.74 | Tₘ 90, 113° C. |
| | | (10 eq) | | | | | | |
| 10 | Y-3-N | DIMAH-D4 | 4.4 | | | | | |
| | | (1.2 eq) / | | | | | | |
| | | DIBAL | | | | | | |
| | | (20 eq) | | | | | | |
| 11 | Y-3-N | MAO | 9.8 | 98 | Vinyl 0.6%, | | | |
| | | (100 eq) | | | 1,4-insertion | | | |
| | | | | | 1.8% | | | |
| 12 | Y-3-N | Ionic MAO | 21.7 | 99 | Vinyl 0.4%, | 2237 | 6.63 | |
| | | (10 eq) | | | 1,4-insertion | | | |
| | | | | | 0.9% | | | |
| 13 | La-3-N | DIMAH-D4 | 4.3 | | | | | |
| | | (1.2 eq) / | | | | | | |
| | | DIBAL | | | | | | |
| | | (20 eq) | | | | | | |
| 14 | La-3-N | MAO | 14.7 | | | | | |
| | | (100 eq) | | | | | | |
| 15 | La-3-N | Ionic MAO | 154.4 | | | | | Tₘ 96° C. |
| | | (10 eq) | | | | | | |

*Conditions: ca 1 g BD, toluene solution, BD: M = 2500; 250 psi ethylene; 100° C.; 14 hours;
**1,2-cyclopentane.

Significant cross-linking upon copolymerization of ethylene and butadiene, activated by ionic MAO, can be mitigated if the reaction is performed in the presence of a chain-transfer agent, DIBAL (Table 4). The molecular weight of the polymer decreases upon increasing the concentration of DIBAL. Overall, the composition of the copolymer remains almost identical for the reaction mixtures involving various equivalents of DIBAL.

TABLE 4
Polymerization data for the Sc-3/ionic MAO system
in the presence of various equivalents of DIBAL.*

| | Activity | C₂, | BD (vinyl/1,4-trans/1,4- | M_{w}, | | |
|---|---|---|---|---|---|---|
| Activator | (kg_{polymer}/mol_{Sc}) | mol % | cis), cC₅**, mol % | kDa | PDI | DSC |
| I-MAO, | 231.3 | 81 | (2/8/3), 7 | cross-linked | | Tₘ |
| no DIBAL | | | | | | 96° C. |
| I-MAO, 20 eq | 247.8 | 81 | (1/6/8), 4 | 138 | 3.70 | Tₘ |
| DIBAL | | | | | | 100° C. |
| I-MAO, 40 eq | 253.9 | 81 | (1/6/8), 4 | 122 | 4.45 | Tₘ |
| DIBAL | | | | | | 102° C. |
| I-MAO, 60 eq | 241.7 | 82 | (1/5/8), 4 | 113 | 5.21 | Tₘ |
| DIBAL | | | | | | 102° C. |

*Conditions: ca 1 g BD, toluene solution, BD: M = 2500; 250 psi ethylene; 100° C.; 5 hours.

Overall, catalyst systems of the present disclosure having bis(phenolate)-type catalysts based on rare earth elements in combination with TMA-free MAO and/or ionic MAO can be used for producing copolymers of ethylene and butadiene under mild conditions with high conversions. The catalyst systems disclosed herein are attractive options for implementation into industrial scale processes for the high throughput production of copolymer materials, e.g., derived from ethylene and butadiene monomers, having tailorable physical properties, polymer backbone architecture, and varying functional moieties. In addition, polar side chain moieties can be incorporated into the polymer chains over the course of copolymerization. Such functionalized polymers can be desirable for the tire industry due to enhanced interactions between the copolymer and filler(s) present with the copolymer during use as a tire material.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

1. A solution catalyst system comprising:
1) an anion modified alkylaluminoxane, and/or
a cation modified alkylaluminoxane, wherein the solution catalyst system has 0 wt % to about 2 wt % Al from non-coordinated trialkylaluminum compound, based on total aluminum content of the solution catalyst system as determined by titration of the solution catalyst system with tetrahydrofuran; and
2) a compound represented by Formula (I): 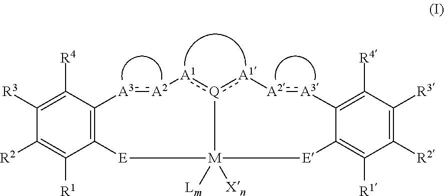
wherein:
M of is a group 3 transition metal or a lanthanide metal;
E and E′ are each independently oxygen, sulfur, or NR^{A} wherein R^{A} is independently hydrogen, C₁-C₄₀ hydrocarbyl, substituted C₁-C₄₀ hydrocarbyl, or a heteroatom-containing group;
Q of is a group 14 atom, group 15 atom, or group 16 atom;
A¹QA^{1′} are part of a heterocyclic Lewis base containing 4 to 40 non-hydrogen atoms that links A² to A^{2′} via a 3-atom bridge with Q being central atom of the 3-atom bridge;
each of A¹ and A^{1′} is independently carbon, nitrogen, or C(R^{B}), wherein R^{B} is selected from hydrogen, C₁-C₂₀ hydrocarbyl, and substituted C₁-C₂₀ hydrocarbyl; 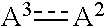
is a divalent group containing 2 to 40 non-hydrogen atoms that links A¹ to the E-bonded aryl group shown in Formula (I) via a 2-atom bridge, and A³ and A² are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings; 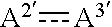
is a divalent group containing 2 to 40 non-hydrogen atoms that links A^{1′} to the E′-bonded aryl group shown in Formula (I) via a 2-atom bridge, and A^{3′} and A^{2′} are combined to form a substituted hydrocarbyl ring, an unsubstituted hydrocarbyl ring, a substituted heterocyclic ring, or an unsubstituted heterocyclic ring each having 5, 6, 7, or 8 ring atoms, and wherein substitutions on the ring can join to form additional rings;
each L is independently a Lewis base;
X′ is an anionic ligand;
any two L groups may be joined together to form a bidentate Lewis base;
an X′ group may be joined to an L group to form a monoanionic bidentate group;
n is 1;
m is 0, 1, or 2;
n+m is not greater than 3; and
each of R¹, R², R³, R⁴, R^{1′}, R^{2′}, R^{3′}, and R^{4′} is independently hydrogen, C₁-C₄₀ hydrocarbyl, substituted C₁-C₄₀ hydrocarbyl, a heteroatom or a heteroatom-containing group, or one or more of R¹ and R², R² and R³, R³ and R⁴, R^{1′} and R^{2′}, R^{2′} and R^{3′}, R^{3′} and R^{4′} may be joined to form one or more substituted hydrocarbyl rings, unsubstituted hydrocarbyl rings, substituted heterocyclic rings, or unsubstituted heterocyclic rings each having 5, 6, 7, or 8 ring atoms, and where substitutions on the ring can join to form additional rings.

2. The catalyst system of claim 1, wherein the anion modified alkylaluminoxane comprises an electron withdrawing group.

3. The catalyst system of claim 2, wherein the electron withdrawing group comprises —F or —OC₆F₅.

4. The catalyst system of claim 3, wherein the non-coordinated trialkylaluminum compound is trimethyl aluminum.

5. The catalyst system of claim 4, wherein the fluorine-containing compound comprises at least one compound selected from the group consisting of NH₄BF₄, (NH₄)₂SiF₆, NH₄PF₆, NH₄F, (NH₄)₂TaF₇, NH₄NbF₄, (NH₄)₂GeF₆, (NH₄)₂SmF₆, (NH₄)₂TiF₆, (NH₄)₂ZrF₆, MoF₆, ReF₆, GaF₃, SO₂ClF, F₂, SiF₄, SF₆, ClF₃, ClF₅, BrF₅, IF₇, NF₃, HF, BF₃, AlF₃, NHF₂, NH₄HF₂, Me₃SiF, Me₂SiF₂, MeSiF₃, Et₃SiF, Et₂SiF₂, EtSiF₃, Ph₃SiF, Ph₂SiF₂, PhSiF₃, Me₃CF, Me₂CF₂, MeCF₃, Et₃CF, Et₂CF₂, EtCF₃, Ph₃CF, Ph₂CF₂, PhCF₃, Me₂BF, MeBF₂, MeAlF₂, Et₂BF, EtBF₂, EtAlF₂, Ph₂BF, and PhBF₂; and the —OC₆F₅ containing compound comprises at least one compound selected from the group consisting of HOC₆F₅, Me₃Si(OC₆F₅), Me₂Si(OC₆F₅)₂, MeSi(OC₆F₅)₃, Me₃C(OC₆F₅), Ph₃C(OC₆F₅), Me₂B(OC₆F₅), MeB(OC₆F₅)₂, MeAl(OC₆F₅)₂, Al(OC₆F₅)₃, and B(OC₆F₅)₃.

6. The catalyst system of claim 1, wherein the cation modified alkylaluminoxane comprises a chelating or monodentate agent.

7. The catalyst system of claim 6 wherein the chelating or monodentate agent comprises a siloxy donor.

8. The catalyst system of claim 7 wherein the siloxy donor comprises dimethylaluminum trihydrocarbylsiloxide.

9. The catalyst system of claim 7, wherein the siloxy donor is derived from a decomposition product of the dialkylaluminum cation stabilized by a chelating polysiloxane or from in-situ generation by the reaction of a silanol with the free alkylaluminum in the alkylaluminoxane composition.

10. The catalyst system of claim 9, wherein the chelating polysiloxane comprises at least one compound selected from hexamethylcyclotrisiloxane, octamethylcyclotetrasiloxane, octaphenylcyclotetrasiloxane, octamethyltrisiloxane (OMTS), decamethyltetrasiloxane, dodecamethylpentasiloxane, tetradecamethylhexasiloxane, or 2,4,6,8-tetramethyl-2,4,6,8-tetravinylcyclotetrasiloxaneat, or the silanol comprises at least one compound selected from trimethylsilanol, triethylsilanol, tripropylsilanol, tributylsilanol, trihexylsilanol, triheptylsilanol, or trioctylsilanol.

11. The catalyst system of claim 1, wherein the alkylaluminoxane of the anion modified alkylaluminoxane and the cation modified alkylaluminoxane is methylaluminoxane, and the non-coordinated trialkylaluminum compound is trimethylaluminum.

12. The catalyst system of claim 10, wherein the alkylaluminoxane composition is obtained from a process comprising a phase separation step to isolate the ionic alkylaluminoxane phase from the non-coordinated alkylaluminum solution phase following by an ionic alkylaluminoxane decomposition step through either heating the ionic alkylaluminoxane at a temperature selected from 50° C. to 120° C. for 0.5 hour or longer or aging at ambient from 24 hours or longer.

13. The catalyst system of claim 1, wherein M of Formula (I) is selected from the group consisting of Sc, Y, or La.

14. The catalyst system of claim 1, wherein each of E and E′ of Formula (I) is oxygen.

15. The catalyst system of claim 1, wherein Q of Formula (I) is nitrogen.

16. The catalyst system of claim 1, wherein each of A¹ and A^{1′} of Formula (I) are carbon.

17. The catalyst system of claim 1, wherein:
A³ and A² of Formula (I) are combined to form a first ortho-phenylene, and
A^{3′} and A^{2′} of Formula (I) are combined to form a second ortho-phenylene.

18. The catalyst system of claim 1, wherein:
A³ and A² of Formula (I) are combined to form a first benzothiophene, and
A^{3′} and A^{2′} of Formula (I) are combined to form a second benzothiophene.

19. The catalyst system of claim 18, wherein each of R^{1′} and R¹ of Formula (I) is independently selected from the group consisting of adamantan-1-yl or substituted adamantan-1-yl.

20. The catalyst system of claim 19, wherein each of R^{1′} and R¹ of Formula (I) is tert-butyl or substituted tert-butyl.

21. The catalyst system of claim 20, wherein each of R³ and R^{3′} of Formula (I) is independently methyl or tert-butyl.

22. The catalyst system of claim 1, wherein each of R², R⁴, R^{2′}, R^{4′}, R⁵, R⁶, R⁷, R⁸, R^{5′}, R^{6′}, R^{7′}, R^{8′}, R¹⁰, R¹¹, and R¹² of Formula (I) is hydrogen.

23. A process for producing a polymer, the process comprising: polymerizing an α-olefin and optional comonomer by introducing the α-olefin and optionally the comonomer with the catalyst system of claim 1, in a reactor, at a reactor pressure of 0.05 MPa to 1,500 MPa and a reactor temperature of 30° C. to 230° C. to form the polymer.

24. A process for producing an ethylene copolymer, the process comprising: polymerizing ethylene and at least one conjugated diene by introducing the ethylene and the conjugated diene with the catalyst system of claim 1, in a reactor, at a reactor pressure of 0.05 MPa to 1,500 MPa and a reactor temperature of 30° C. to 230° C. to form the ethylene copolymer.
